(19) United States
(12) Patent Application Publication
(10) Pub. No.: US 2019/0272064 A1
(43) Pub. Date: Sep. 5, 2019

(54) INSTANT MESSAGING SYSTEMS AND APPLICATIONS

(71) Applicant: KEYLESS SYSTEMS LTD, Jerusalem (IL)

(72) Inventor: Benjamin Firooz Ghassabian, Jerusalem (IL)

(73) Assignee: KEYLESS SYSTEMS LTD, Jerusalem (IL)

(21) Appl. No.: 16/345,405

(22) PCT Filed: Nov. 2, 2017
(86) PCT No.: PCT/IL2017/051196

§ 371 Date: Apr. 26, 2019

Related U.S. Application Data
(60) Provisional application No. 62/418,220, filed on Nov. 6, 2016.
(60) Provisional application No. 62/439,044, filed on Dec. 25, 2016.
(60) Provisional application No. 62/453,083, filed on Feb. 1, 2017.
(60) Provisional application No. 62/515,013, filed on Jun. 5, 2017.

(51) Int. Cl. G06F 3/0481; G06F 3/0488; G06F 3/16; G06F 3/0484; G06Q 30/02

(52) U.S. Cl. CPC G06F 3/0481; G06F 3/04883; H04L 51/04; G06F 3/0484; G06Q 30/0257; G06F 3/16

(57) ABSTRACT

A system comprising a first device having a touch screen a messaging application running in the background within said first device and a window related to said application, said window, regardless of the window of any other application displayed on the screen, is located on an edge of said touch screen while said messaging application is running, wherein upon providing a gesture from said window of said messaging application towards inside of said touch screen, a function related to said messaging application is executed.

The present application claims priority from U.S. patent applications:
application number 62/418,220 filed on 6, Nov. 2016
application number 62/439,044 filed on 25, Dec. 2016
application number 62/453,083 filed on 1, Feb. 2017
application number 62/515,013 filed on 5, Jun. 2017

This application is also related to various prior PCT applications, including PCT/US2016/025127, PCT/US2015/017638, PCT/US2015/017638, PCT/US2014/016777, PCT/US2013/026044, PCT/IL2012/000048, PCT/IL2012/000029, PCT/US2010/002282, PCT/IL2010/001075, PCT/IL2010/000098, PCT/IL2009/000794, PCT/IL2009/000790, PCT/IB2008/002263, PCT/IB2007/004481, PCT/US2006/023524, PCT/US2005/019582, PCT/US2004/012082, WO03/007288, PCT/US2002/041257, PCT/US2001/049450, and PCT/US2000/029647, the disclosures of all of which are also incorporated herein, by reference, in their entirety. The above-mentioned applications may herein be referred to as previous applications.

For simplicity and clarity of illustration, reference numerals may be repeated among the figures to indicate corresponding or analogous elements. Also, similarly named elements perform similar functions and are similarly designed, unless specified otherwise. Numerous details are set forth to provide an understanding of the embodiments described herein. The embodiments may be practiced without these details. In other instances, well-known methods, procedures, and components have not been described in detail to avoid obscuring the example embodiments described herein. The description is not to be considered as limited to the scope of the example embodiments described herein.

### FIELD OF THE INVENTION

The present invention also relates to improve methods of social interaction and/or messaging experience by providing a messaging interface above any virtual content(s) such as a picture or a video, a web page, an animation, etc., which is displayed on the screen. Such a system is herein referred to as keyboard networking system/application, chatting system/application, social messaging system/application, etc.

The present invention also relates to improving such experience by using preferably a small keyboard invented by this inventor as a means of input for social interactions over a network.

The present invention also relates to a method of social interaction by texting on virtual content(s) such as a picture or a video, and controlling and/or securing contents.

### BACKGROUND OF THE INVENTION

With the emergence of devices having touch screens, on screen full (e.g. QWERTY) keyboard systems are used on most devices. Due to the size of mobile devices, and the number of keys of a full keyboard, such keys are reduced in size rendering the keyboard cumbersome and the data entry slow. The screen of a device is intended to display the output. Having a full keyboard with many keys on the screen covers a significant portion of the screen, hindering the use of many current applications and limiting creation of many other applications.

Several data/text entry system have been invented and described by this inventor in different patent applications in the past. Such data entry systems occupy a small portion of the screen therefore permits creation and use of many (social) applications on the small screens such as those of a smartphones.

### SUMMARY OF THE INVENTION

A messaging system wherein its interface is generally above any content/application being opened on the screen is described in detail hereafter (e.g. herein may be referred to as keyboard networking system, chat on any app system, etc.).

According to one embodiment of the invention, people may be members of a (social) networking application (e.g. chat/messaging system) and may interact (e.g. send messages to, content such as an image, audio, invitation etc.) with each other using an interface related to said networking application while also being able to simultaneously interact with an open content/interface related to another application (e.g. herein may be referred to as the main application) is opened on the screen of a device. Preferably the chatting interface overlaps at least a portion of said another app. By using such a keyboard networking system a user can/may chat with others while (e.g. simultaneously) using/interacting (e.g. on the screen) with an additional/other application (e.g. herein the keyboard networking system may be referred to as the chat system/application or first application, and the additional application may be referred to as the/a main application). Preferably, at least a portion of the interface of the keyboard networking/chat system/application (e.g. herein may be referred to as chat interface) overlaps/overlays at least a portion (e.g. the corresponding portion) of the content/output of said/another application/content (e.g. herein may be referred to as the main application) on the screen. This may permit a multi-tasking procedure/mechanism on a (e.g. mobile) device. As an example, a user may surf the Internet (e.g. the main application), open a page/subject or any other output of a main application (e.g. brows, see and/or interact with the output of a main application) and chat with his/her friends about a (e.g. said) page/subject/output of the main application or about any other subject. His/her friend may also see/open/interact-with the same subject/page or another subject/page/application on their device and use the chat application of the invention to chat (back and forth). All methods of identifying, inviting, sending messages, history of chatting, individual and/or group methods of chatting systems, creation of a group, hiding and/or unhiding methods of at least a portion of a content (e.g. after) being shared (e.g. a mask covering at least a portion of a message being sent/shared, etc., as being described in the previous applications filed by this inventor) and more such methods as those used by the content editing application of the invention may be implemented with the keyboard networking system of the invention.

According to one aspect, at least a portion of a shared/sent/outgoing message may be encrypted/not shown/masked (e.g. as described in detail herein) to one or more users among a number users with/to which a message/content is shared/sent. Note that in the keyboard networking system of the invention, a data entry field (e.g. such as a text box/field) may be used to view a message typed (e.g. and to be shared) by the user using an input method such as a/the keyboard.

Note that a text field may belong to (e.g. be part of or under control of) said additional/other (e g main) application, or may belong to the keyboard networking system (e.g. each of both applications may have its own text fields. A data entry field dedicated (e.g. under control of) the data entry system (e.g. keyboard) may herein be referred to as the keyboard entry field or chat field).

Note that the keyboard networking system of the invention may have its own user interface (e.g. herein may be referred to as chat interface). Said chat interface may include at least one of a/the keyboard, a data entry field (e.g. corresponding to entering a text which may be saved or shared/sent with/to others, a field/zone corresponding to displaying a received/incoming message, a send/receive means, a (one or more) chat icon (i.e. button) (e.g. herein may also be referred as contact icon/button) (described below), etc. Note that according to a preferred method, a receiving message and a sending message (e.g. a message being type, to be sent) may use a same data entry field.

According to a preferred method, a user may receive a notification from another user sending him/her a message. According to one method, (e.g. automatically and/or manually upon receiving a predefined interaction from the receiving user), a means such as an icon/button may be displayed on the screen of the receiving device (e.g. herein may be referred to as chat icon/button) (e.g. using the chat system of the invention. By interacting with said chat icon/button, a corresponding chat interface (e.g. at least a data entry field and/or the keyboard) may be presented on the screen so that the user may start chatting with the corresponding user or a corresponding group of users. A “Send” means/button (e.g. not shown) may be used to send the entered information/content.

According to one embodiment, upon an interaction with a chat icon/button, the corresponding data entry field may be presented on the screen with or without the keyboard being presented on the screen. By interacting with the data entry field the/a keyboard may be presented on the screen.

According to a first method, a corresponding received message may be presented separately from a data entry field. According to a second method, the data entry field may display/include a received message and a message being entered by the user of the receiving device.

Note that a receiving message and a sent message may use (e.g. be displayed on) a same data entry fields or on separate fields.

According to one method, the message/content sent/shared may be encrypted such that to be decrypted by an authorized user(s). Such authorization may be provided in several ways (e.g. simultaneously or separately), for examples provided by the owner/administrator of the group, of the owner/creator sending the message/message, and/or by the sender of the message/content

According to one embodiment said an additional/other/main application (e.g. content/photo/video editing application) (e.g. of the system) and the keyboard networking system of the invention may be merged/combined (e.g. to form an integrated service or application).

According to one method, the data entry system may target any data entry field (e.g. text box, text field, picture edit box) of any addition/other application/main For example, the data entry system of the keyboard networking application may provide text/content to an application (e.g. similar in manner that a keyboard would enter information to an application).

According to one method, preferably the data entry system of the keyboard networking system may only be displayed/enabled for an active/targeted data entry field in an (e.g. additional/other) application.

According to one method, the keyboard networking system may enable users to interact with each other such that they may provide a portion (e.g. all, some) of the content (e.g. text) of (e.g. any) a data entry field (e.g. text field), or other content as the user may like while watching/interacting with a main content. For example, a user may (type a) message or send a/said content and/or a reference/information corresponding to a/said content (e.g. for simplicity, any of them, herein may be referred to as content) to another user while viewing an internet application from of an online competition. Such content may include information (e.g. such as text, hyperlinks, audio, video, images, etc.) from the Internet application form/page (e.g. a link, a photo) and/or some other information source/Internet page.

According to one example, any application may purposely provide a data entry field (e.g. visible or invisible) or instruct the data entry system or keyboard networking system to popup, for example, so that users of said application (e.g. or any other application regarding the keyboard networking system) may interact while using an application (e.g. in conjunction with the keyboard networking application).

Note that the keyboard networking system of the invention may include users using different keyboards. As an example, a cooperation between two keyboard manufacturers may result in using/sharing a same keyboard networking system, wherein users using a first type of keyboard can chat/communicate with users of a second type of keyboard. According to another example, the keyboard networking system may be restricted to use a/the data entry system of the invention.

Note that the keyboard networking system may have its own networking system or may use another networking/messaging system (e.g. an existing networking/messaging system such as SMS, IM, etc.).

### BRIEF DESCRIPTION OF THE DRAWINGS

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 100 is schematic illustration a keyboard networking system in accordance with an exemplary embodiment of the invention.

FIGS. 100A-100M are schematic illustrations of exemplary interface of a messaging system in accordance with an exemplary embodiment of the invention.

FIGS. 101A-101L are schematic illustrations of exemplary interface of a messaging system in accordance with an exemplary embodiment of the invention.

FIGS. 102A-101I are schematic illustrations of exemplary interface of a messaging system, on a device in landscape mode, in accordance with an exemplary embodiment of the invention.

FIGS. 102J-102M are schematic illustrations of exemplary interface of a multi-media messaging system, in accordance with an exemplary embodiment of the invention.

FIGS. 103A-103E are schematic illustrations of writing on an image in a messaging system in accordance with an exemplary embodiment of the invention.

FIGS. 103F-100H are schematic illustrations of exemplary interface of a messaging system in accordance with an exemplary embodiment of the invention.

FIG. 104A is a schematic illustration of exemplary method of popping of an interface of a messaging system in accordance with an exemplary embodiment of the invention.

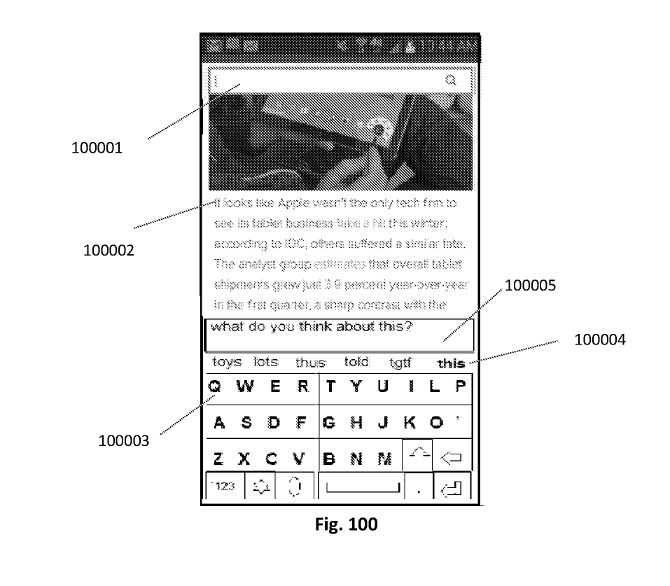

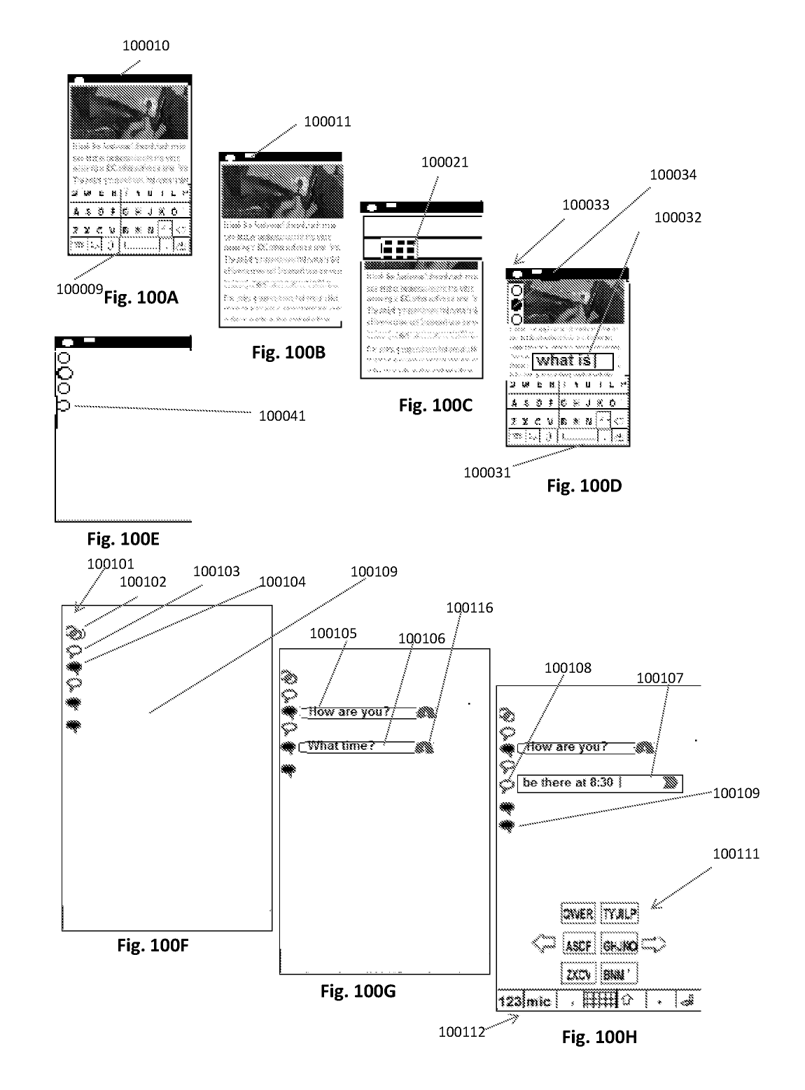

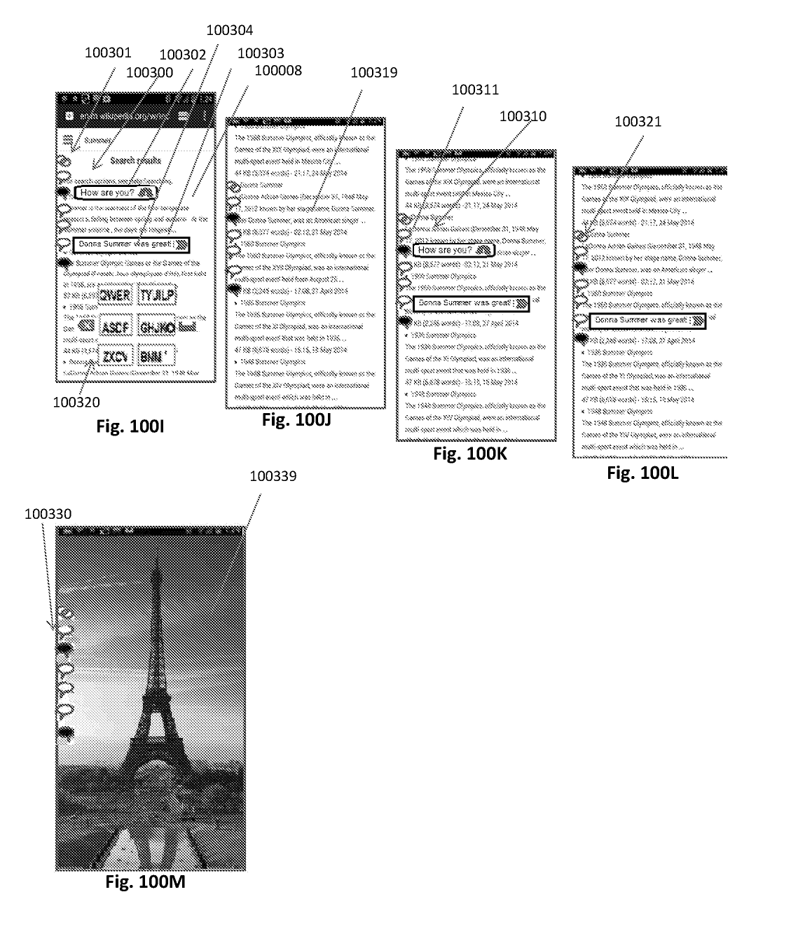

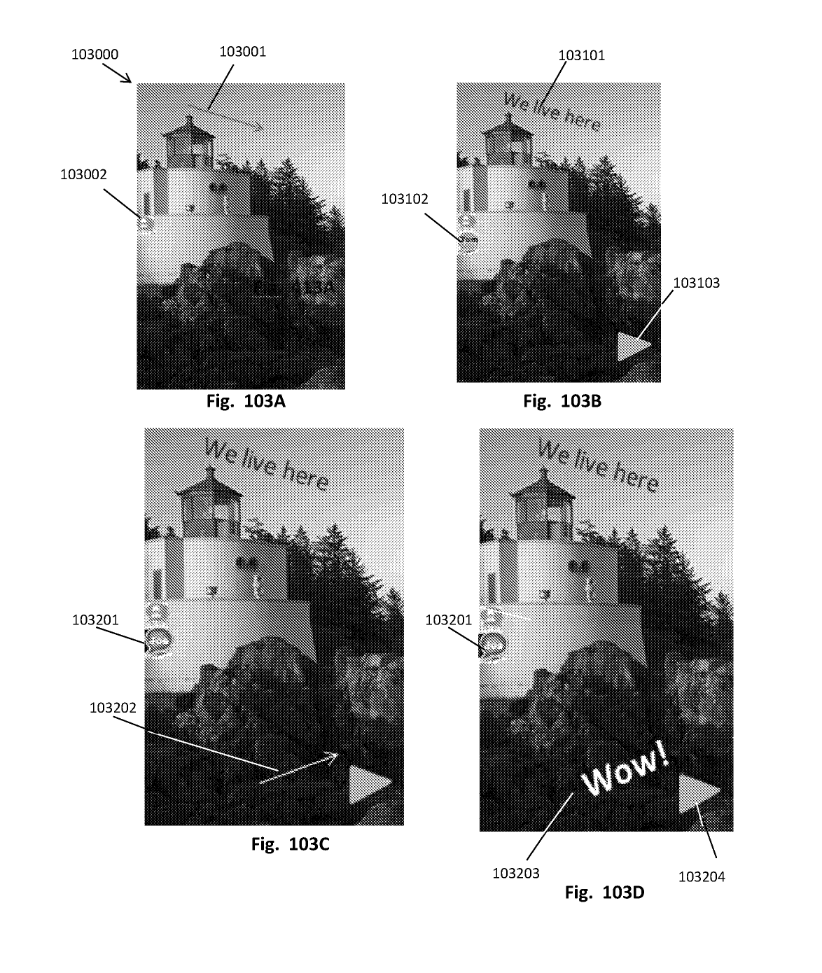

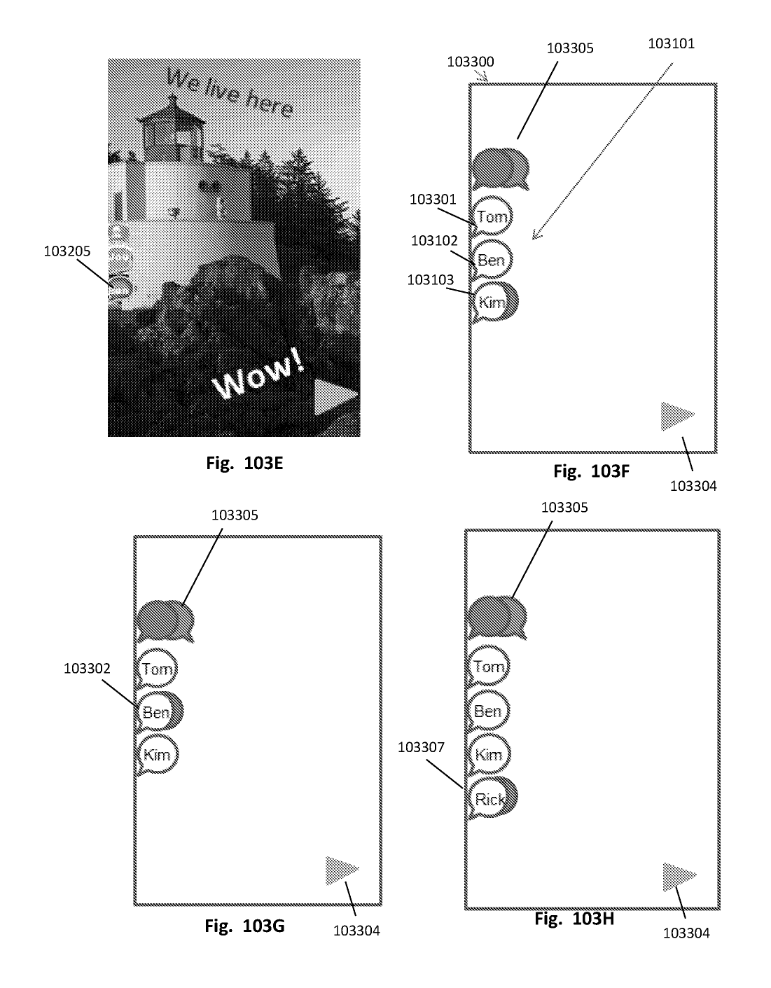

FIGS. 103F-100H are schematic illustrations of exemplary principles of a messaging system in accordance with an exemplary embodiment of the invention.

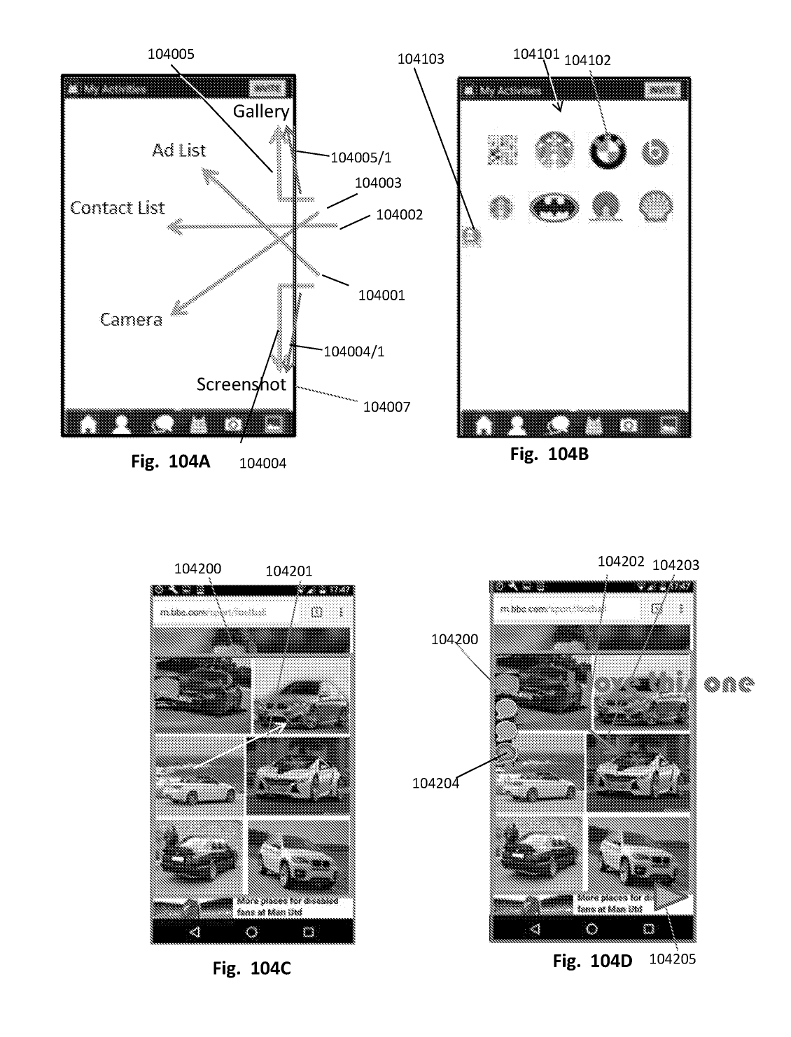

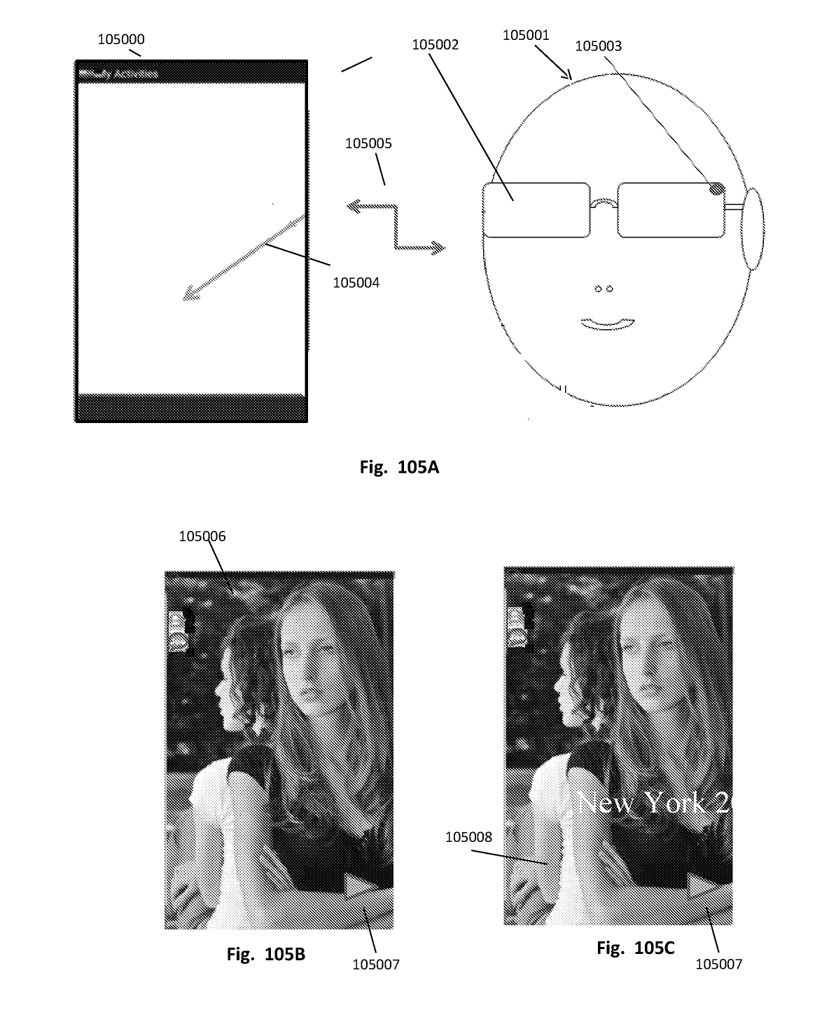

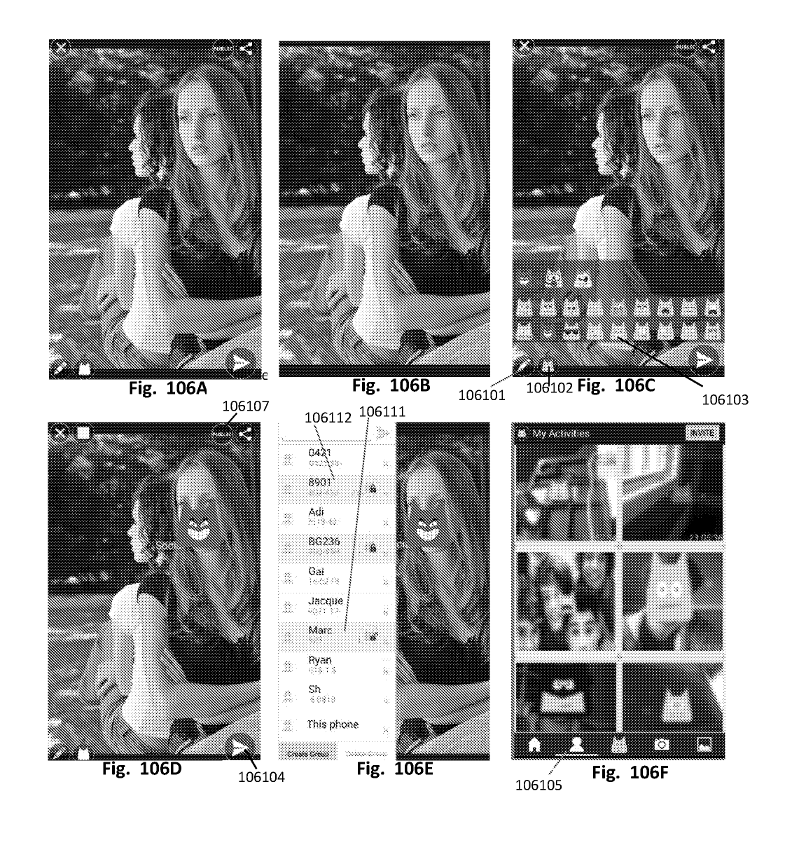

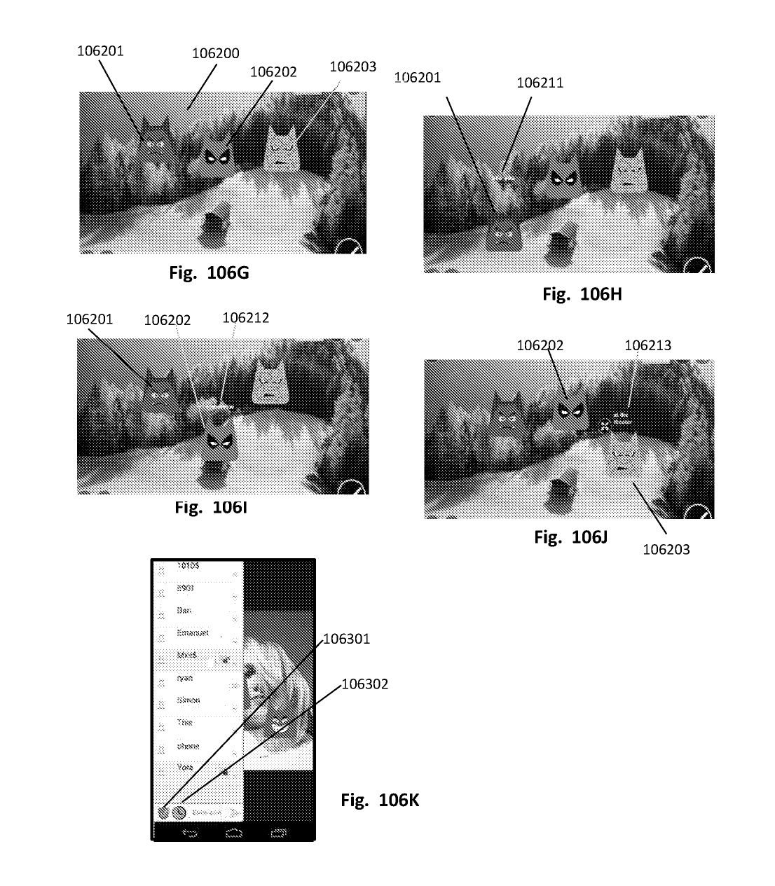

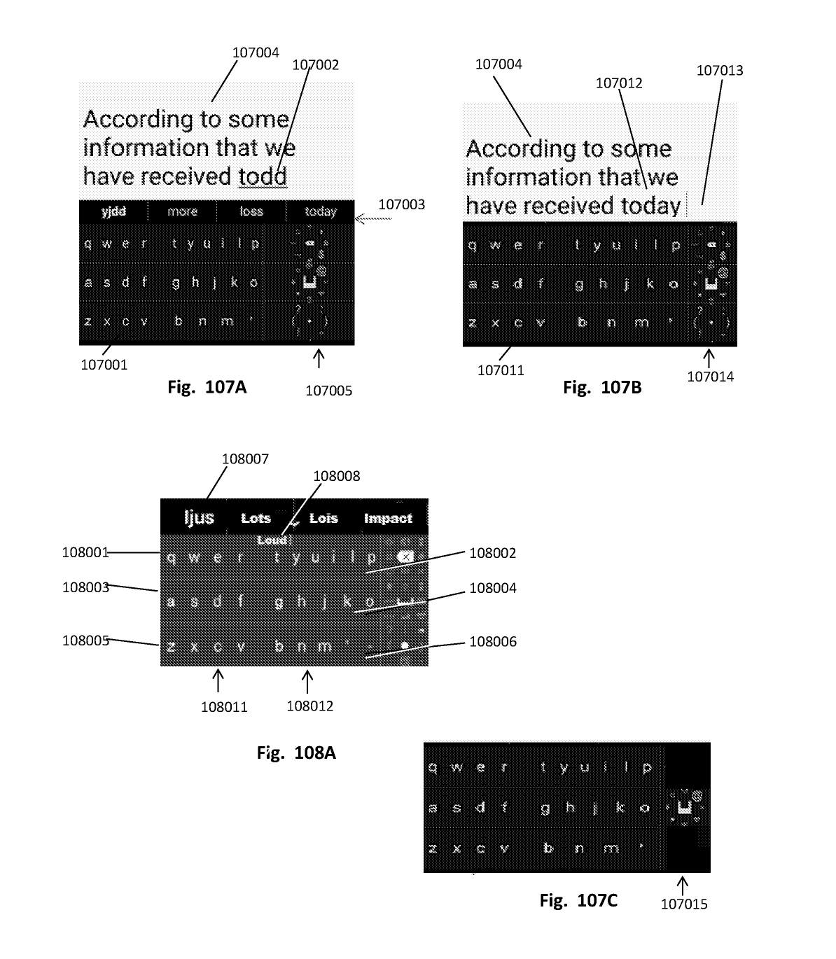

FIGS. 104A-104D are schematic illustrations of exemplary principles of a messaging system in accordance with an exemplary embodiment of the invention.

FIGS. 105A-105C are schematic illustrations of exemplary principles of a messaging system, using a camera with glasses, in accordance with an exemplary embodiment of the invention.

FIGS. 106A-106K, are schematic illustrations of exemplary masking and/or unmasking principles in a messaging system, in accordance with an exemplary embodiment of the invention.

FIGS. 107A-10C and FIG. 108A, are schematic illustrations of some principles of a data/text entry system, in accordance with an exemplary embodiment of the invention.

### DETAILED DESCRIPTION OF EMBODIMENTS

An example of the current embodiment is shown in FIG. 100. In this example, a device having a touch screen surface is displaying a content 100002 (e.g. a webpage) on the/a touch screen. A keyboard 100003 is presented on the touch screen, for example, by touching a text entry field 100001 of the content. In this example, a keyboard entry field 100005 is also displayed and accessible to the user. A word list 100004 relating a word being entered is also displayed. In this example, the text being entered by a user is entered into the keyboard entry field 100005 so that to be sent to one or more users using the keyboard networking system. By viewing a content on the screen and being able to communicate (e.g. chat) with other users (e.g. simultaneously), users can discuss about the content on the screen and/or about other subjects.

According to one embodiment, upon activation of the keyboard networking system of the invention, a notification is preferably sent to the (e.g. operating system of a/the) corresponding/current device such that when a user opens the notifications page/view (e.g. by interacting with/sliding on a/the notification bar of the device) and interacts with said notification, a chat interface of the keyboard networking system of the invention may be presented/printed on the screen. According to another embodiment, upon activation of the chat system its (e.g. initial, last state/instance) chat interface may be presented on the screen. Said chat interface may be presented fully (e.g. including the chat icons/buttons (e.g. each corresponding to a chat (room) with a different user/group, wherein said chat (rooms) may be preferably be live/open/current chats, and/or closed chats, and/or on pause chats, or chats corresponding to received messages that are waiting to be opened (e.g. and replied), a keyboard, a data entry field, etc., a zone/field to display a received message, etc.) or it may be partially (e.g. only chat icons/buttons) presented on the screen. Note that a same data entry field may be used to display a chat interaction including received messages and sent messages (e.g. replies). According to one aspect, a such notification may preferably always be available in the notification bar/page.

Preferably, upon interacting with said notification (e.g. or when the chat system is activated), a means such as an icon/button may be displayed on the screen to permit selecting a user/group of users (e.g. herein referred to as a group) opening new chats with a user/group from a list of users (e.g. herein maybe referred to as contacts or contact list) and/or group of users.

According to a preferred method, when the user interacts with a (e.g. an outgoing) chat icon/button, the/a keyboard and/or a (e.g. corresponding) data entry field become available on the screen (e.g. over/next to the output of the second/main application). Preferably, the data entry field is used to enter any content such as at least one of a text, a photo, a video, an audio, etc. Said data entry field is preferably also used to display any output, such as a chat history, photos, etc.). Preferably, typing on the keyboard provides the corresponding text inside said data entry field. Said keyboard and/or data entry field may be displayed on the screen while an output of said second/main application is also displayed on the screen (e.g. each occupying a (e.g. different) portion of the screen or overlapping said second output). Accordingly, interacting with the button of an incoming message preferably opens said incoming message.

According to one embodiment, said data entry field may preferably belong/related to the keyboard networking application or it may belong to another (e.g. an external) networking/messaging application (e.g. SMS application) used by the keyboard networking system (e.g. of the invention).

According to one method, when (e.g. an instance of) the chat interface (e.g. an icon, a keyboard and/or data entry field, etc.) is displayed on the screen, preferably an invisible or substantially transparent view/glass covers a (e.g. substantial) portion of the second/main content on the screen such that when the user interacts with (e.g. taps/glides on) said view/glass, said view/glass and/or at least a portion of the chat interface (e.g. preferably the keyboard and/or the data entry field, any opened chat) is/becomes removed/closed to permit access (e.g. to full view, and/or manipulation such as, select, navigate, scroll, etc.) to said second/main content. According to another (e.g. preferred method) the/said chat interface may preferably mainly cover/overlay the/a corresponding portion of the main content (e.g. the portion of the main content which is under the chat interface. The rest of said main content is not covered as is accessible to a direct interaction) on the screen such that to permit interacting (e.g. directly) with said content. In this case, according to a first method upon a/said (e.g. direct) (e.g. predefined) interaction (e.g. scrolling, tapping, etc.) with the main content preferably the chat interface remains as is (e.g. unchanged). According to another method, upon said (e.g. direct) interaction with said another/main content the system may remove at least a portion of the chat interface as described. Note that as mentioned, after removing/deactivating the keyboard networking system, a notification as described earlier is preferably sent to the device such that when the user opens the notifications page (e.g. by interacting with a/the notification bar of the device) and interacts with said notification, the chat interface and preferably the corresponding keyboard and/or the data entry fields become available on the screen.

Note that the data entry field may include the chat history between one or more users. It may include the outgoing and incoming messages/contents exchanged between the corresponding users.

According to one method, an interaction (e.g. tabooing, gliding, scrolling) action provided directly on the second content may remove at least a portion (e.g. text fields, keyboard) of the keyboard networking system from the screen.

According to a preferred embodiment, by bringing up a keyboard and a corresponding data entry field by using any procedure such as the procedure described above, a method of chatting between users of (e.g. mobile) devices may be created. Said method of chatting may be used while (e.g. simultaneously) any second/main application (e.g. a web page, a document, a video, a game, a photo, etc.) is being displayed on the screen.

According to one aspect, upon opening the chat interface, a chat list (e.g. forming a (e.g. vertical) bar/row (e.g. herein may be referred to as chat bar) preferably located on an edge of the screen) including one or more chat icons/buttons each preferably corresponding to a chat (e.g. chat room/history) with a corresponding user/group may be presented on the screen, over at least a portion of the existing content and without removing it from the screen, such that by interacting with one of said icons/buttons, the user can open a chat (e.g. interface) with a corresponding user/group. Preferably, said chat list corresponds to the users/groups that are currently in chat with the user of the device. A user interaction, for example, such as a gliding action or long press on an icon/button may terminate said chat and preferably delete the icon/button from the (chat) list. Note that according to one aspect, if there is no current chat with anybody, said chat list does not pop up, and preferably only the main button (e.g. 100102 of FIG. 100F) remains on the screen. In addition to the current chats icons/buttons, a means such as a button (e.g. herein may be referred to as the main button of the (chat) interface) may be available (e.g. become available when the chat list or chat interface is open, or when a user opens the keyboard networking system of the invention, by for example from the notification bar/page) so that the user can open an additional list of users/groups (e.g. any contacts list such as the contact list of the device, a list of Facebook friends, etc.) to select a user/group and open a new chat (e.g. opening a new instance of chat interface corresponding to the new chat). Preferably, upon such selection a corresponding chat icon/button may be added to the current chat list.

Note that the word chatroom which is known by people skilled generally refers to a channel of remote messaging between two parties of a messaging application. A party may be an individual user or a group of users. In the keyboard networking/application system of the invention, as being described and shown herein, a chatroom is represented by a chat icon (e.g. 100104).

By using such a chatting procedure, users of mobile devices can chat together at any desired moment even/preferably while a content corresponding to another/main application is displayed the screen. They can bring up the chat interface and chat while said content is displayed on the screen. They can chat about said content (e.g. a video, a game, a (e.g. medical) document, etc.) or about any other subject. Note that preferably said chat interface remains on the screen over any of second/main content even when a second/main content is changed by another second content (e.g. said second content may for example be a web page and may be changed/replace by opening another application such as a document, a picture from the gallery of the device, taking a photo using the camera of the device, etc.) on the screen. Preferably, at least a portion of said chat interface (e.g. permanently) remains on the screen over a such second/main content (e.g. or a new main content that replaces said second/main content) preferably at all time and may be removed under a predefined condition such as by the user providing a predefined interaction (e.g. pressing the main button of the interface). Preferably, the interface portion of the keyboard networking system covers/overlays (e.g. overlays) the corresponding portion of (e.g. the content) of the second application on the screen. The rest of the content of the second/main application can be viewed and/or accessed by the user.

Note that preferably, the input provided by the keyboard which is popped up as just described may preferably/mainly be related to enter text in the data entry field of the chat interface. As such the regular usage of a keyboard (e.g. popping up by tapping in a regular text field) may not be affected.

Preferably, a user can enter text in any text box on the screen regardless of to which (e.g. of the two) applications it belongs. As an example, the user may interact with the text box of the main application and enter text in said text box, or he/she may tap in a text field of the keyboard networking application and enter text within said text field.

Preferably, the system may permit multiple chats (e.g. simultaneously). At least the corresponding chat icons/buttons may be presented on the screen. Preferably, the user may switch between chats by interaction with the corresponding chat icons/buttons. Preferably, the icon/button preferably corresponding to the current/open chat may be highlighted.

It is understood that other methods of notification (e.g. for the same purpose) may be created/used by people skilled in the art.

An example of some of the principles of a keyboard networking system of the invention is described through FIG. 100A to 100D. In FIG. 100A the screen of a device having a popped up touchscreen keyboard 100009 is shown. A notification bar 100010 of the device is also displayed on the screen. According to one method, if a user removes the keyboard networking system from the screen, then as shown in FIG. 100B, a notification 100011 is sent to the device (e.g. to notify that there is no keyboard networking system that is now activated). Then, as shown in FIG. 100C, the user may open the notification list and tap on the/a corresponding received notification 100021 to activate the chat application which as shown FIG. 100D it will result in popping up a chat interface (e.g. fully (e.g. including the chat icons/buttons, keyboard, data entry field) or partially (e.g. chat icons/buttons only) on the screen. The user may tap on a desired chat button/icon 100034 in the chat list/bar 100033 to select/open a chat (e.g. may open the full chat interface if it was partially opened) with a desired user/group.

Note that when the keyboard networking system of the invention is activated, an incoming message may automatically pop up a corresponding chat icon/button on the screen (e.g. see chat icon/button 100041 of FIG. 100E). Note that a/the chat interface may be partially displayed/opened. For example, it may exclude a keyboard and/or the data entry field. As an example, the opened portion may be the chat icons/buttons. Then by tapping on an icon/button a corresponding (e.g. full) a chat interface may be opened on the screen.

Note that according to one method, a user may open more than one chat (e.g. by interacting/tapping on more than one chat icon/button) simultaneously. In this case, preferably multiple corresponding data entry fields and/or incoming messages may be opened, (e.g. simultaneously). The user may select any of said opened chat rooms by providing a predefined interaction such as interacting with (e.g. tapping on) the opened data entry field or incoming message of a corresponding chat room.

According to one embodiment, a user using the keyboard networking system of the invention may be able to exchange information/chat with another user that does not use the keyboard networking system of the invention (e.g. such a network, herein may be referred to as an external networking application. e.g. SMS). In this case, the incoming messages received from an external networking system may (also) be redirected to a/the keyboard networking system of the invention. Accordingly, the outgoing messages from the keyboard networking system of the invention may be sent/directed through/to an/said external networking system.

According to one method, a predefined interaction with a keyboard (e.g. of the invention), may popup the keyboard entry field.

According to one method, a content (e.g. such as a URL, text, image, etc.) may be entered to the entry field and sent by using the keyboard networking system. According to another method, a content (e.g. such as a URL, text, image, etc.) may be acquired (e.g. copied) from (e.g. anywhere in) the/an additional/other/main application into a keyboard entry field of the keyboard networking system and preferably send to other users.

According to one method, a user may active the keyboard networking system (e.g. popping up a keyboard and/or text entry field, history, the corresponding chat interface, a Contacts list, etc.) by providing a predefined interaction such as by providing a gesture from the edge (e.g. of the screen) of the device, interacting with/tapping on a text field of another application, etc.

According to one embodiment, upon opening/activating the keyboard networking system, a/the chat bar may become available and permanently be open to display the corresponding chat icons/buttons (e.g. herein may be referred to as chat bar) on the screen. According to another embodiment, as described before, upon opening/activating the keyboard networking system, preferably in addition to opening a user/chat interface of the keyboard networking system, a notification may preferably be sent to the (e.g. local) device such that each time the interface of the keyboard networking system is removed from the screen, upon interacting with said notification an interface of the keyboard networking system preferably the chat bar/list may become available to display the corresponding chat icons/buttons on the screen. Said chat bar may be removed from the screen or become hidden upon a providing a predefined interaction such as removing the chat bar (e/g/ all of the chat icons/buttons) from the screen, or by removing for example, the icon/button corresponding to the contacts, or simply by pressing a predefined key/zone, etc. Said chat bar may be reactivated by for example again interacting with/a the notification sent to the device when the keyboard networking system was first opened/activated. According to another method, when closing/removing the interface of the keyboard networking system (e.g. the chat bar (e.g. which preferably also includes the button corresponding to the contacts)) the system may send a notification to the device such that interacting with said notification may re-open the chat bar. According to another method, when removing said chat interface (e.g. the chat bar), the keyboard networking system and preferably the corresponding notification closes/removes. Upon opening/activating the system again, a notification is again sent to the device.

Note that, the embodiments, methods, principles, example, described above are used to describe the principles of the keyboard networking system of the invention. It is understood that other methods, examples, etc., may be used to use the keyboard networking system of the invention. For example, the keyboard used with the keyboard networking system may be any type of keyboard from any source (e.g. the chat interface of the system may permit/pop up/accept any/a native keyboard of the device used by a user, or a keyboard dedicated (built-in) the keyboard networking system). Also as an example, closing the system and/or removing the corresponding notification may be done upon completion of any other predefined condition.

Also as an example, according to one embodiment, when (e.g. each time) a chat interface (e.g. of the keyboard networking system) (e.g. herein may be referred to as a/the first application) is not displayed on the screen or removed from the screen of a device (e.g. and preferably an output of/related to a second/main application such as a web page, a document, a photo, a video, etc. is displayed on the screen), a notification similar (e.g. for the same purpose) to the one described above may be sent to the device so that interacting with said notification opens/displays the partial or full chat interface corresponding to the keyboard networking system of the invention.

Note that preferably, although the keyboard networking system may accept input from any input method (e.g. keyboard from any keyboard supplier, a voice recognition system, a handwriting recognition system, etc.), it may include a means to allow input from a preferably specified input method (e.g. keyboard).

A preferred keyboard networking system and a corresponding exemplary interface is described hereafter. FIG. 100F, shows a chat interface of the system having a chat bar 100101 including several chat (e.g. incoming and outgoing message) buttons. Preferably, an incoming message button (e.g. 100104) and an outgoing message button (e.g. 100103) are presented differently. They may be different in color, shape, etc. Note that the chat interface of the keyboard networking system (e.g. generally) overlaps at least a corresponding portion of a content/output of the/a second/main application which its output is preferably printed on the screen (e.g. note that an output of a main application may include any content (e.g. even an input field). As mentioned before, the main application may be of any kind (e.g. a web page) and may be changed/replaced by a new main application (e.g. a video, a photo application displaying a photo on the screen, a text document, etc.). Upon activating a new main application, preferably, the keyboard networking system of the invention may remain activated and its interface may overlap the content/output of the new main application on the screen. By overlapping a portion of the/a main application, as mentioned, preferably, the user can interact with both the chat application and the main application preferably simultaneously. Note that in the current example, the content of a main application is not shown on the screen 100109.

As mentioned, a user may initiate/start a chat by selecting a user/group (e.g. of users) from a list of users. For this he/she may interact with the/a corresponding button (e.g. 100102, herein may be referred to as the main/contacts button) of the chat interface to open the/a list of users (e.g. contacts) and select one or more users to (e.g. write/type and) send them messages. The user may also initiate a chat with a new user not from the/a list (e.g. by providing the telephone number (e.g. and/or some other identifying information) of a new user). As mentioned a chat/message bar 100101 may include the icons of one or more incoming and/or outgoing messages. As shown in FIG. 100G, a user may open one or more received messages to view them. For that the user preferably interacts with a/their corresponding chat button(s). In this example, the user has opened the received messages 100105 and 100106. The user may replay to one or more messages by providing a predefined interaction preferably with a corresponding chat interface portion. As an example, in FIG. 100H the user is responding to the received message 100106 of FIG. 100G (e.g. by tapping on the corresponding reply button 100116). When responding, the chat button of the response message (e.g. 100107) may change to another form/color/etc., (e.g. 100108). Note that in this example, a new message is received and its corresponding chat button 100009 is displayed in the chat button bar.

Note that according to one method, the chat buttons may not form a chat bar/ They may be presented separately from each other (e.g. on opposite sides) on the screen.

Note that preferably, a user may be able to view a receiving message and respond to it. Preferably the user may switch between the corresponding received/incoming and outgoing messages. According to another method, both, the incoming and the outgoing messages may be shown in a same view/edit box (e.g. as history).

According a preferred method, if a user sends an outgoing message, the corresponding chat interface including its corresponding incoming and/or outgoing buttons is/are deleted from the screen. In this case according to a preferred method, preferably the corresponding incoming and outgoing messages are deleted from the system and no trace/history is kept/memorized/saved. According to another method, the history of (e.g. none shown/deleted) chats may be saved and may be accessed at a later time, on demand (e.g. by providing a predefined interaction (e.g. with a key of the system)), by/through another application, etc.

According to another method, if a user sends an outgoing message, the corresponding chat/text field is closed but its corresponding incoming and/or outgoing buttons are not deleted from the screen, so that the user can send additional messages to said user/group.

According to one embodiment, a user may close an opened received/incoming or outgoing/draft message by providing a predefined interaction such as tapping on the corresponding chat button. Several (e.g. three) scenarios may be considered:

a) In case of closing a response being typed (e.g. draft) to an incoming message, preferably, the corresponding chat button will turn to an incoming message button. When the user interacts with said button again, at first the incoming message will preferably be presented. Preferably from there (e.g. by tapping on the/a reply button (e.g. 100116), the user may re-open the reply/response message and preferably continue his previous response from the instance that he closed it.

b) in case of closing a chat initiated/started by the user (e.g. of the device) without receiving a corresponding incoming message (e.g. a new chat) the system preferably keeps the corresponding outgoing chat button.

c) in case of closing an incoming message the system preferably keeps the corresponding incoming chat button.

Note that other scenarios may be considered based on the principles described herein.

Note that, when the system enters into the/a reply instance (e.g. a text input box is presented to the user), a keyboard (e.g. 100111) may become available (e.g. pop up automatically or manually on the screen) to/by the user.

FIGS. 100I to 100L are exemplary drawings to demonstrate additional principles of the current (e.g. keyboard networking system) invention. In FIG. 100I, the messaging/chat system (e.g. keyboard networking system) of the invention (e.g. herein may also be referred to as SMSnap) is used within a device. In this example, the interface relating to an instance 100300 of the messaging system is shown (e.g. covering/overlaying a portion of the a content 100308 of a main application displayed on the screen). The chat button bar 100301 shows a number of received messages wherein one of them 100302 is opened, and a number of outgoing messages wherein one of them 100303 is open and a user is using a keyboard 100320 available on the screen to input text in the corresponding text field 100304. An internet/web page 100008 is open on the screen and the user is chatting/typing about a subject (e.g. Donna Summer) included in said Internet/web page. According to a preferred method, upon interacting with the/a main content on the screen (e.g. scrolling the internet/web page for/to view more information (e.g. see internet/web page 100319 of FIG. 100J), tapping on it, long pressing on it, etc.), the system may preferably automatically close all of the opened fields/chats of the chat interface. According to one method, as shown in FIG. 100J, the system preferably shows their corresponding chat buttons. This may permit an almost complete/full view of the corresponding main content (e.g. the web page) on the screen. According to a preferred method, in this case, at any moment, upon a (e.g. predefined) interaction such as interacting with any of the buttons of the chat bar, the system may re-store/re-open the chat interface preferably in its/the instance before it was (e.g. automatically) closed by the system. In the current example, as shown in FIG. 100K, after the user interacts with the chat button 100311, the system re-opens an/the instance 100310 of the chat interface similar to the instance 100300 of the chat interface of FIG. 100I when that was closed (e.g. preferably including the keyboard). Note that, preferably, in the meantime if a new incoming message is received, its corresponding chat icon may also be added to the re-stored chat interface. According to one method, as shown in FIG. 100K, the revived/reinstalled interface may exclude the keyboard.

The user may continue his/her interaction with the system/interface. For example, as shown in FIG. 100L, the user may tap on the chat button 100321 to close its corresponding chat window/field.

As mentioned the system preferably stays activated (e.g. and at least a portion of its interface stays on the screen) when a user changes a current main application to another main applications.

In FIG. 100M, shows the chat interface (e.g. and the chat system) remaining activated after the user changes the main application to another application (e.g. a video 100339 being played on the screen), and wherein the chat interface 100330 of the system overlays a portion 100339 of the output (e.g. a video) of the new main application.

Note that according to one method, when a message is received, it may automatically be opened and shown on the screen.

Note that the history of chats may be tagged (e.g. by user name, date, subject, etc.) and accessed based on any tags.

Note that, when opened, the function bar may preferably overlap the text message box so that chat interface occupy a minimal portion of the screen and/or the main content which is open on the screen.

Note that the SMSnap may be used on/with any content or activity (e.g. on the screen) such as a webpage, a video, a photo, etc. people may watch a same or different videos (e.g. games, live sport video streams, etc.)

According to one method, during reading and/or typing a message all other portions of the chat/SMSnap interface may be removed from the screen. They may be re-shown on the screen preferably after sending or closing said message.

Note that the button corresponding to bringing up the/a contact list on the screen (e.g. 100101 of FIG. 100A) may also be considered as part of the chat buttons bar. According to one aspect, only up to a predefined number of chat buttons may be presented to the user, after which, a predefined (e.g. more) button may be/become available on the screen so that interacting with said button provides more chat buttons on the screen adding to or replacing the current chat buttons shown on the screen.

According to one method, after closing a message being entered (e.g. without sending it or replaying), the icon corresponding to a replay message may be remained/shown on the screen such that if the user interacts with said icon the system re-opens said message.

Preferably, each time a non-finished/non-sent/draft message is reopened the system shows/reinstalls the instance of said message as when is was closed last time.

According to one method, after sending a message, the corresponding chat and preferably the corresponding send and/or receive chat buttons are deleted. According to one aspect, the history of said chat may be memorized so that to be accessed if desired. According to another aspect, all history of said chat will be destroyed.

According to one embodiment, size of a chat field (e.g. of incoming or outgoing message/content or both combined (e.g. a chat history)), history, etc., may be enlarged or reduced by a user or automatically.

According to one aspect, upon a predefined interaction such as providing a long-pressing action on the/a contacts button (of/in the chat bar), the (e.g. chatting) system may become closed/deactivated (e.g. the interface of the chatting system may be removed from the screen). In this case as mentioned before according to one method a notification is preferably sent to the user's device, wherein upon interacting with said notification, the system is re-activated on/in the user's device. According to another method, the/a notification is always available in the notification bar/page of the device.

According to one method, the chat interface, partially or entirely, may be brought up on the screen upon providing an interaction such as providing a gesture from an edge of the screen towards inside the screen, from a menu of the device (e.g./i.e. the notification bar), etc. The chat interface may be removed by providing a predefined interaction such as providing a gesture in the opposite direction on the screen, from a menu of the device, etc.

Note that the SMSnap/chat application/system is preferably not used for messaging only. It can also been used locally on the user's device to enter text (e.g. and save it.). For example, a user can/may read an article, view a document, see a video, etc., and take notes using the SMSnap/chat system of the invention. For that, while the system is activated, a predefined interaction such as tapping on a predefined button presented by the system on the screen may open a data entry field (e.g. a text field). A keyboard may be automatically by the system or may be manually by the user popped up in the screen. The user may then enter text within the text field. He may then be able to save the entered text. Note that the saved message may be sent to another user at a later time.

Note that the input of text within a text field of the SMSnap/chat system/chat application (e.g. which is herein also referred to as a/the keyboard networking system) may be provided by any input system or means such as a keyboard, a speech recognition system, a handwriting recognition system, etc.

According to one aspect, the chat buttons and the corresponding chat fields corresponding to an incoming message may be shown/printed on a first side of the screen of a user's device, and the chat buttons and the corresponding chat fields corresponding to an outgoing message may be shown/printed on a second (e.g. the opposite) side of the screen of the user's device.

According to one aspect, the application may have a means to take a (e.g. one or more) screenshot(s) to, for example, share/send it to others. Preferably, the application may also permit selecting/taking a contact such as sharing photos, videos, ground/space positioning, taking a picture(s), and sharing them.

As mentioned, the application may have its own networking system, permitting to create group chats, individual chat, using the masking/unmasking system of the invention to mask a content to be shared, and the methods of unmasking it, etc. A received shared content may be resized such that to be displayed on a portion of the screen of the received device (e.g. reduced size) and/or it may be enlarged to substantially cover the said screen (e.g. enlarged size). Same resizing may be applied to any other content (e.g. relating to the application) such as the history of chat with a party.

According to one aspect, when a message is received and/or sent, an alerting means such as an audio or visual alert may be performed to alert the receiving party. Said alert may vary upon a completion of a condition such as for example from which party a message is received, etc. A specific alert may be assigned as such may be selected manually (e.g. by the owner of a device) or automatically by the system. For simplicity purpose, a user/device sharing/sending a content with/to others may herein be referred to as a sender, and a user receiving a/said content may herein be referred to as a receiver.

According to one aspect, a content shared with others in any content sharing application may be disappeared from the receiving party's device/screen upon a completion of a (e.g. one or more) condition(s) such as for example after a predefined lapse of time. According to a preferred aspect, a user sharing such a content may select some (e.g. one or more) of people with whom he/she shares the content such that the shared content does not disappear/remove (e.g. automatically and/or upon completion of said condition) from their device/screen. According to another concept the selected people are those that the content disappeared/is removed upon completion of a condition while on other receiving user's devices the content remains on the screen/device.

The chatting application of the invention may include additional features such as camera, photo attachment, ground positioning (e.g. of the user's device), call back (e.g. calling the party that has sent a (e.g. an opened) message, short history (e.g. reduced size history of chat with a person/group), large history (e.g. history displayed on substantially whole screen), etc. Said features may be accessed from a menu list/bar. Said menu list may be opened by using a means such as a button. Said button may be within a chat. According to one method, upon interaction with the main button of the chat application said menu list may be opened. According to one method, said menu list may also include a button for opening the contact list, while according to another method, upon interaction with the main button in addition to the menu list the contact list will also become open.

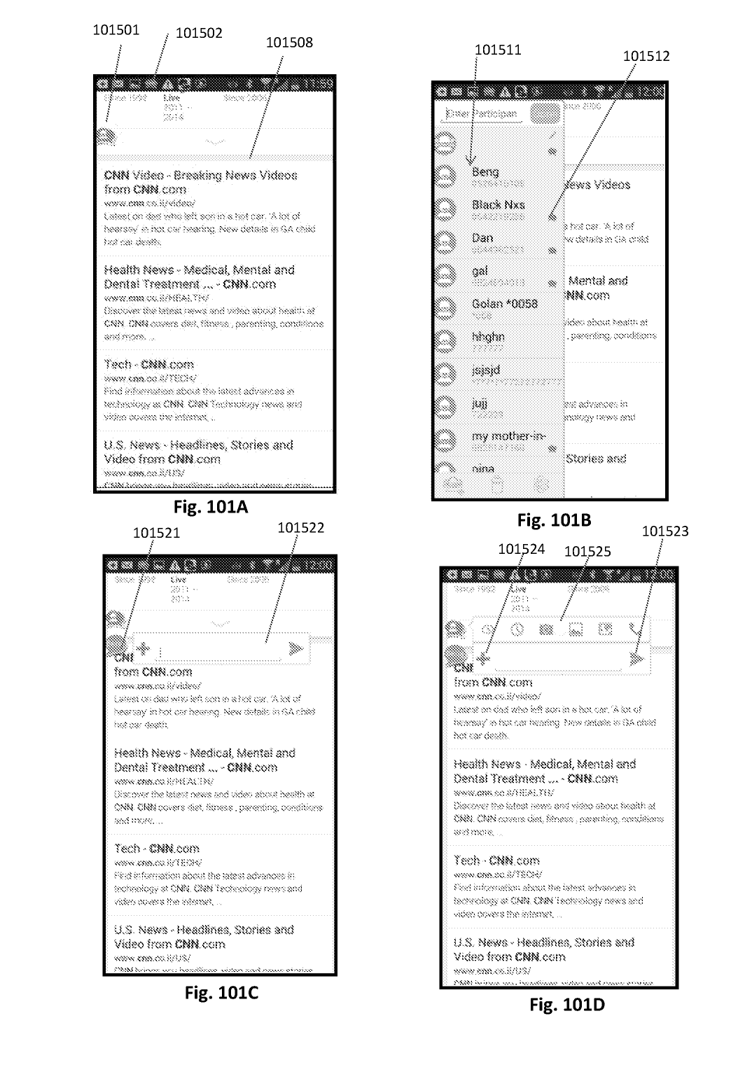

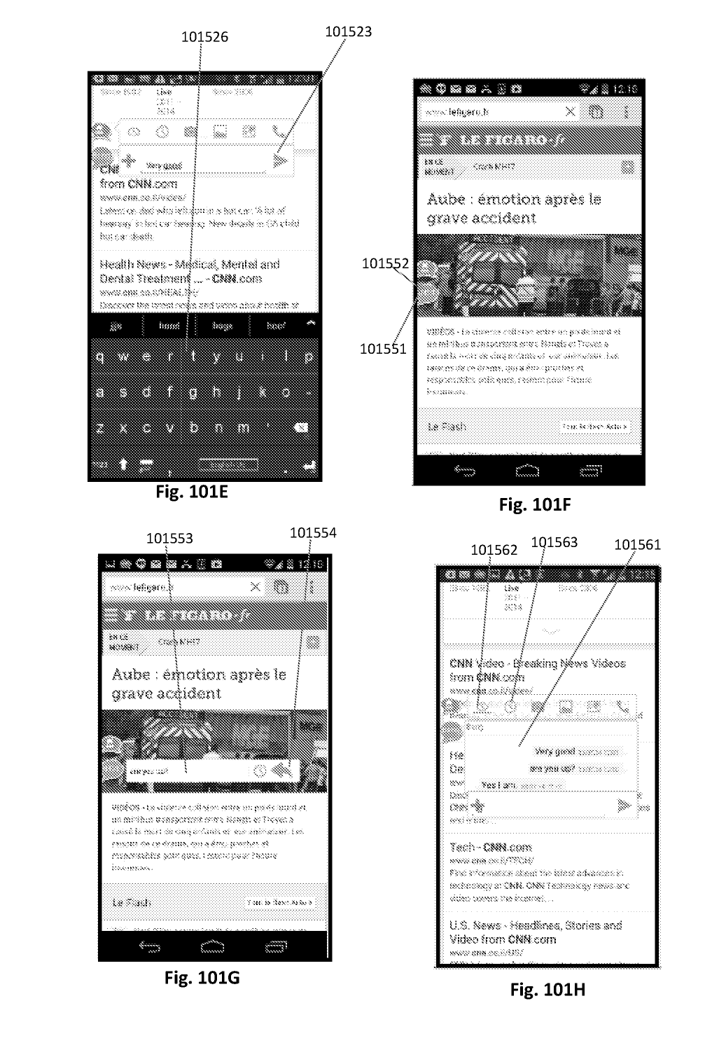

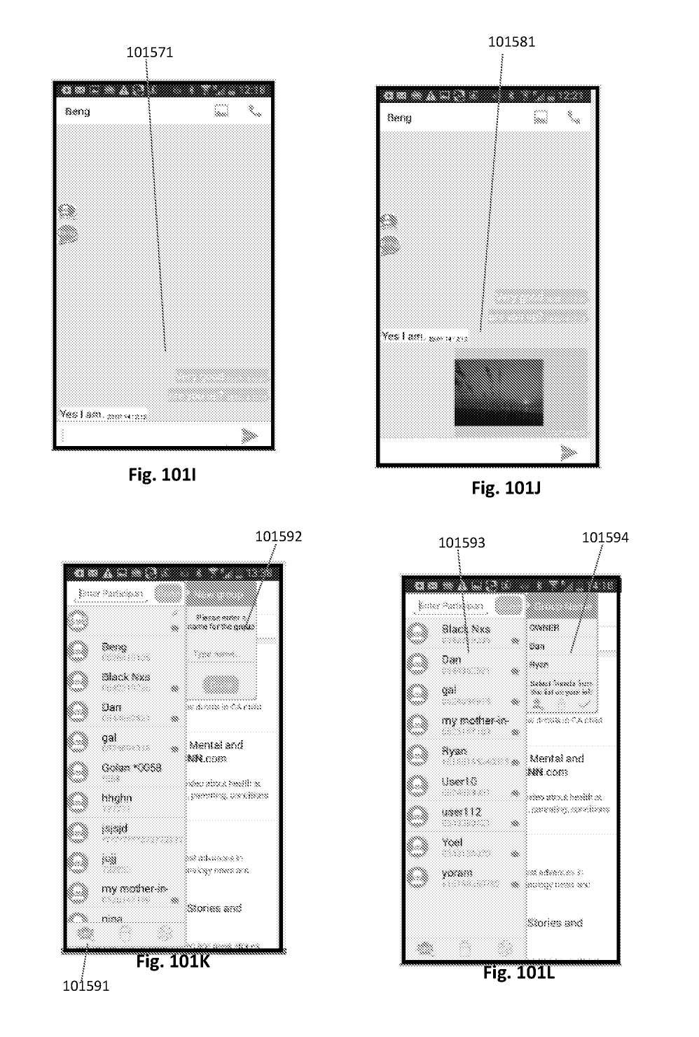

FIGS. 101A to 101L show an exemplary preferred interface of the chat (e.g. on any app) application on the invention. FIG. 101A shows a device of a first user having installed the chatting application of the invention and wherein the main menu (e.g. or main/contacts button) 101501 is preferably popped up on a content 101508 on the screen of the device. As mentioned, preferably said main menu and other components of the interface of the chatting application is present on the screen above or together with any other content or any other application on the screen permitting the user to preferably interact simultaneously with both/any/all applications. Note that said other/any other content or any other application may herein be referred to as the other application. Note that the chatting interface may preferably remain on the screen preferably above any other application even if a second other application replaces a first other application on the screen. As mentioned, according to a preferred method, a long pressing action on the main button 101501 removes the chatting application from the screen. To bring it back, the user may use the notification bar/page 101502 in which the chatting application button may always be present or may become present after the user removes the application from the screen or, optionally, after some other event (e.g. a system event).

According to one method, an interaction such a tapping action on the main button may present the/a contact list 101511 to the user, as shown in the example of FIG. 101B. In the contact list an icon 101512 highlights a user that has the chatting application of the invention on his/her device and/or use the networking system of the chatting application, or, optionally, some means of interacting with the chat (e.g. on any app) application of the invention. As mentioned before according to one method, other systems of messaging such as a SMS system may be used for chat with the users that do not have the chatting system of the invention. In any case, preferably, all/some incoming messages received through the chatting network of the invention or from any other network may be integrated in the chatting system of the invention and/or shown to the user using the chatting system of the invention.

In FIG. 101C, after selecting a user, an icon 101521 corresponding to a/the chat(s) (e.g. herein may be referred to as a chatroom icon) may be presented on the screen preferably adjacent to an edge of the screen. Preferably said icon may be dragable/moveable on the screen preferably by a user. A tapping action on said icon (e.g. or automatically upon selecting a user, the system) may open at least a portion of a corresponding chat interface. In this example, the opened portion 101522 is a text box to type a message and sending it by tapping on a send button/icon 101523, as shown in FIG. 101D. In FIG. 101D, an interaction with an icon 101524 preferably corresponding to the selected chatroom may open a corresponding chat menu/function bar 101525 for accessing additional features such as to a camera or to a gallery for taking/selecting a photo or video and sending it (e.g. automatically) preferably to the selected user, a button corresponding to calling (e.g. automatically) preferably the selected user, sending a ground positioning map regarding the location of the device/user, etc.

In the example of FIG. 101E, upon an interaction such as selecting a user or upon interaction with the text field 101522, a keyboard 101526 may become available so that the user can type a message and send it to the/a corresponding user.

FIG. 101F shows the device of a user to which the/a message is sent. Upon receiving a message, a corresponding chat icon 101551 may become present on the screen (e.g. if said chat icon is not already present on the screen) and/or an alert may preferably inform the user of the incoming message. Said alert may be an audio, vibration, or visual (e.g. 101552). According to one method, upon interacting with the chat icon the system opens the received chat 101553 (e.g. in FIG. 101G). According to another method, upon receiving a message the system opens the received chat 101553 automatically. The user may reply to the received chat opening a sending message interface upon for example an interaction such as tapping on a reply icon 101554.

Note that a user may chat simultaneously with different users (e.g. multi-chatting system). In this case according to one method several chat interfaces may be at least partially open on the screen. According to another method, when only one chat interface can be open on the screen and other current chats may be closed and be represented by their chat icons only. In this case when a user opens a closed chat, the other open chat will be automatically closed and only its icon will be present on the screen.

As mentioned before, the system may include additional features. One of said features may be displaying the history of the chats with a person/group (e.g. history of a chatroom). According to a preferred method the system may have a reduced in size chat history 101561 (e.g. FIG. 101H) and an enlarged chat history 101571 (e.g. FIG. 101I). Said chat histories may be opened by providing a predefined interaction such as providing respectively a tapping on the buttons 101562 and 101563 (e.g. as shown in FIG. 101H).

As mentioned before, any of the chat histories may include any content (e.g. text, image, video, audio, etc.). In FIG. 101J, the history 101581 includes text and image.

The system may also include a (e.g. simplified) creation of a group chat. As shown in FIG. 101K, upon interacting with a means (e.g. interaction with the button 101591) corresponding to creating a group chat, the user may present an interface 101592 to name a group (e.g. by a user), and, preferably, then as shown in FIG. 101L the user may select a number of users from a/the (e.g. contact) list 101593 to include then in a/the group 101594. According to one method, a group may include an (e.g. one or more) individual and/or a (e.g. one or more) group.

Note that a (e.g. contact) list may include a (e.g. created) group too.

Note that the methods, aspects, descriptions, drawing, etc., described here are examples to describe the principles of a chatting system that is targeted to be available on/with any other app preferably simultaneously.

Other methods, aspects, descriptions, drawing, etc., may be considered by people skilled in the art for the same purpose.

In the/an/any messaging system (e.g. SMSnap) wherein a portion of its interface is preferably (e.g. permanently) presented over (e.g. overlaps) a main application which is open on the screen, according to one embodiment, the function bar of the messaging system may include more keys/icons corresponding to different functions. As an example one of the keys may correspond to opening a search interface (e.g. a search web page such as the Google search page), a URL search field, etc. Another key may correspond to calling a person/entity for which a chat icon is presented on the screen (e.g. upon receiving a message, opening a chat, etc.). The chat icon may be presented, for example, by selecting a contact from the application's contact list or it may correspond to a received message, etc. By interacting with the icon/button corresponding to an open chat, the system may call the corresponding person/entity. Note that similar icons/buttons may be used for any type of other functionalities. As an example, the function bar may include a button/icon wherein interacting with it opens a document (e.g. locally on the device or remotely from the internet), open a corresponding URL, etc. This may permit collaboration between the provider of a such messaging system and any other entity such as another business, company, etc.

As mentioned before, the chatting/messaging interface of the messaging/chatting application of the invention may partially overlap the screen and/or the interface of another/any application which is open on the screen (e.g. at any time) (e.g. independently from said another application). According to one embodiment, one or more of the function icons/keys in the chatting application may be related to a selected/another application. For example, by interaction with said key/icon a gaming application may be opened, a web page of a gaming application me be accessed, an advertisement may be presented to the user, etc.

Preferably, at least a portion of the chatting application may be transparent/invisible so that the icon discretely occupy the screen of a device while being accessible easily.

Note that according to one embodiment, at least the (e.g. interface) of the chatting application may be located on the screen of any device such as a television (TV), a PC, etc., permitting instant/permanent chatting/messaging with others while for example watching a TV program, working with the computer, etc.

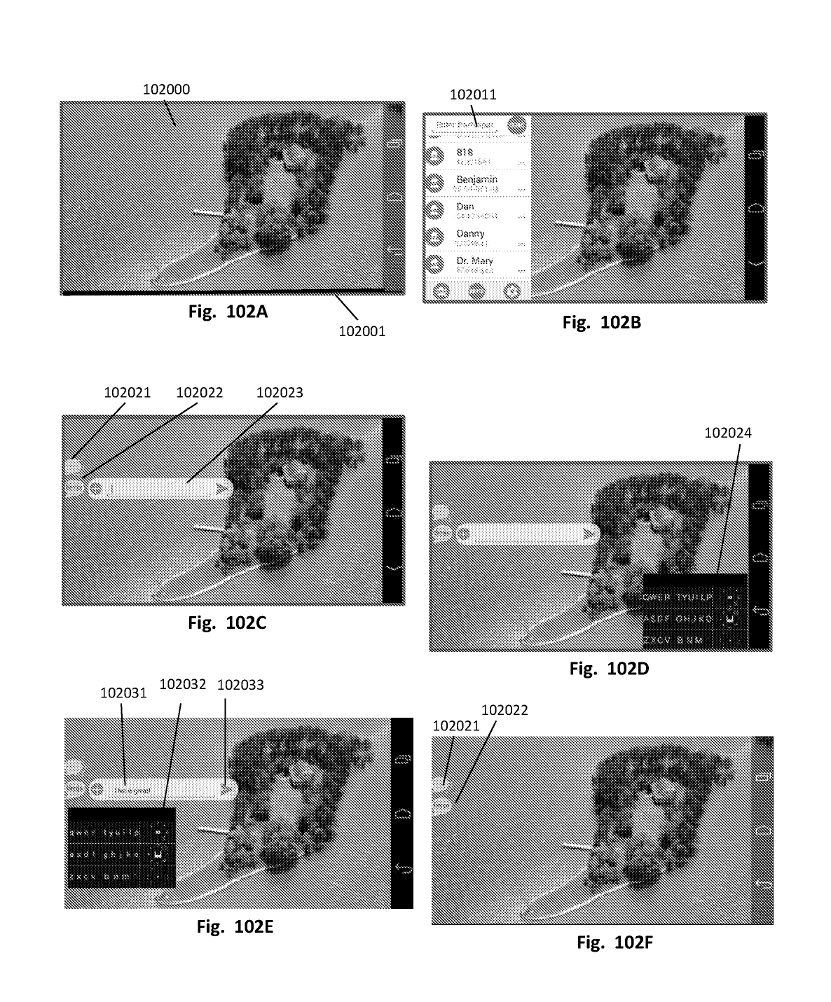

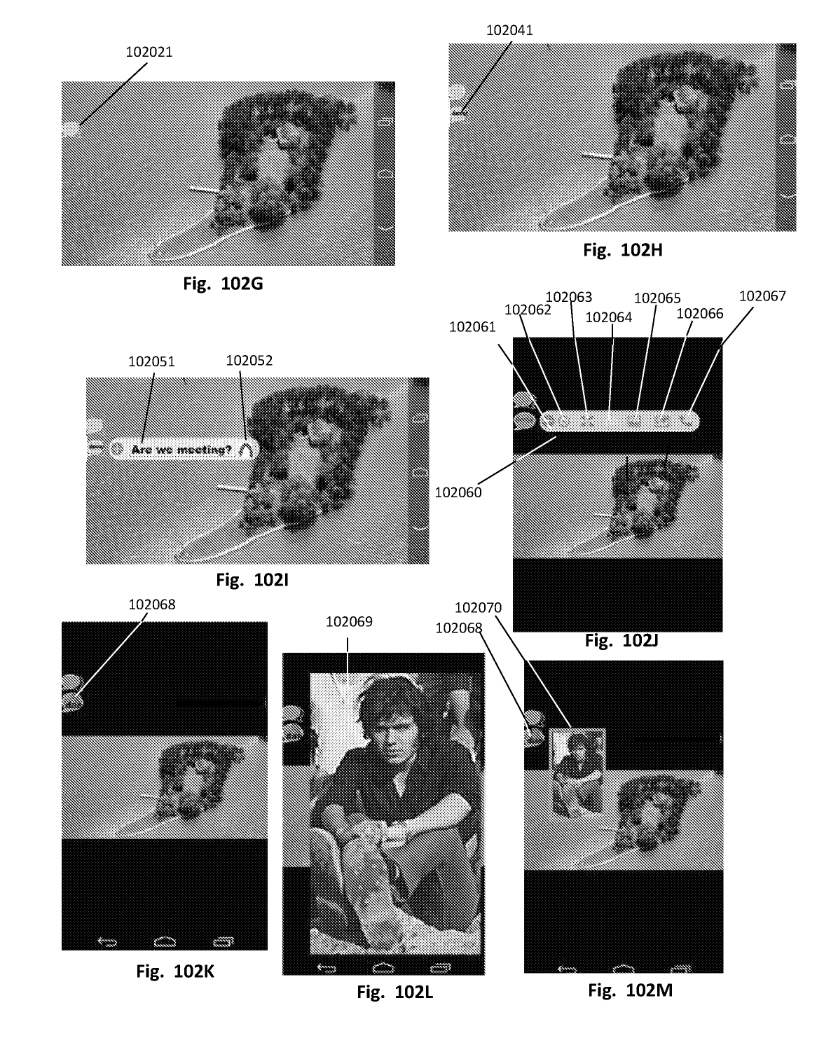

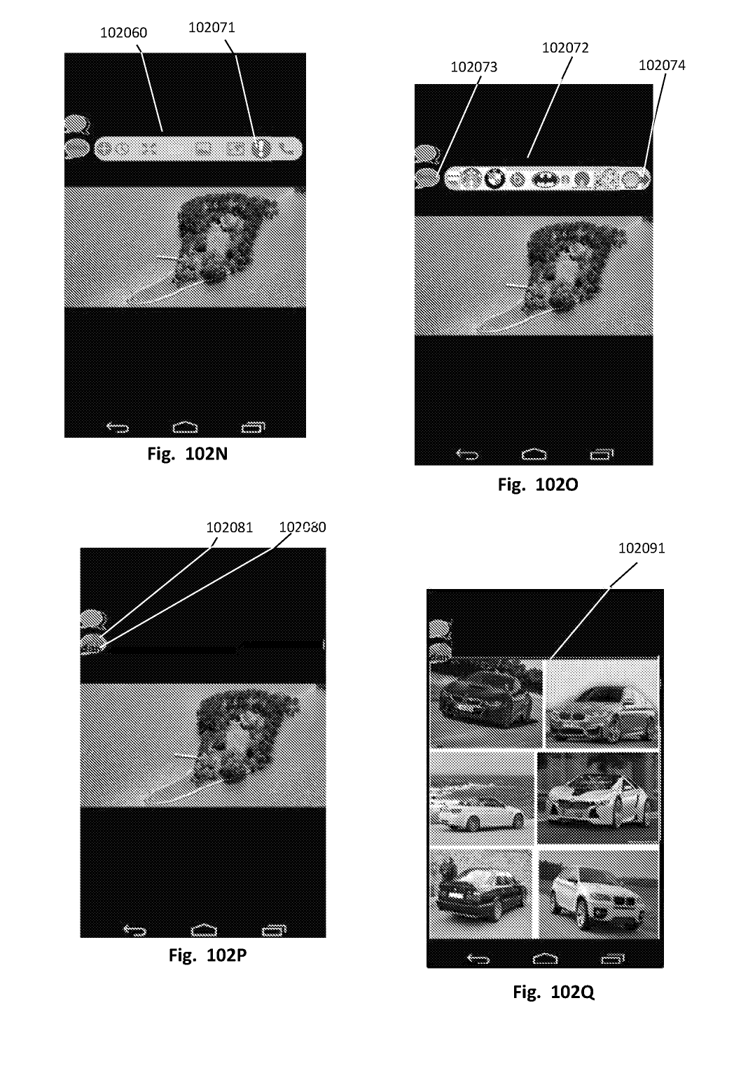

(e.g. in the keyboard networking system of the invention) In order to not occupy (a portion of) the screen of a user's device while said user is not chatting with others (e.g. while the chatting system/application is running in the background), a method is described herein. FIG. 102A shows an image 102000 being displayed on the screen of a device using the Keyboard Networking system (e.g. herein may be referred to as the chatting system/application) of the invention. In this example, no chat interface is displayed on the screen, In order to initiate a chat, the user may provide a gesture from an invisible/narrow window 102001 located on an edge of the screen (e.g. herein may be referred to as invisible bar) towards (e.g. a predefined direction) inside the screen (Providing a gesture from an edge of the screen towards inside the screen using (e.g. preferably) an invisible/very narrow window located on an edge of the screen has been described in detail in previous patent applications filed by this inventor which are herein incorporated by reference (Herein may be referred to as previous applications). Note that said window is preferably located (e.g. permanently or optionally (e.g. always) when the corresponding application (e.g. the keyboard networking system of the invention) is active) on an edge of the screen preferably regardless of (e.g. the interface of) any application which is running on the screen). By doing so, as shown in exemplary FIG. 102B, according to a first aspect, a contact list 102011 of the chat application may preferably be displayed/popped-up on the screen. Upon selecting a contact (to chat with) from the list, as shown in exemplary FIG. 102C, the corresponding chat icon 102022 and/or chat (e.g. text) field 102023 preferably display on the screen. Preferably, the main chat icon/button 102021 (e.g. corresponding to contacts list used by the system/application) is also displayed on the screen. According to a second aspect, as shown in exemplary FIG. 102D, preferably in addition, the system displays automatically a (corresponding) keyboard 102024 on the screen. Preferably, said keyboard is small in size and can be moved/dragged to a desired location on the screen. In the exemplary FIG. 102E, the user has moved the keyboard to a new location 104032 and has typed a message 104031. By pressing the send button 102033, said message will be sent to the corresponding party. As shown in FIG. 102F, after sending a message, preferably the corresponding chat icon 102022 remains on the screen. Preferably, the main chat icon 102021 also remains on the screen. Note that interacting with chat button/icon may result in displaying a/the corresponding contacts list on the screen for selecting one or more users.

According to one embodiment the system may not include the main icon/button or the main icon/button may be discarded permanently or periodically (e.g. automatically based on a condition or upon user request/manipulation). In this case, according to one method, the contact list may be brought up on the screen through other means such as by providing a gesture from the edge of the screen as described herein. To delete/remove a (e.g. selected) contact icon/button (from the screen) the user may long press (a first threshold) on said icon/button and in order to delete/remove all of the selected icons the user may press a longer time (a second threshold) on a (any) selected icon/button.

With the continuous description of the current embodiment, as shown in FIG. 102G, instead of providing a gesture to pop-up the contact list and initiate a chat, the main chat icon 102021 (e.g. corresponding to the contact list) may (e.g. always) be displayed on the screen.

According to one aspect, after providing said gesture, at first the main chat icon/button is displayed on the screen and upon providing an interaction with (e.g. touching) said main chat button/icon, a/the corresponding contacts list may be displayed on the screen for selecting one or more users.

According to one method, a (e.g. predefined) gesture provided from a chat icon preferably removes said icon and the corresponding chat interface (e.g. chatroom) from the screen. According to one aspect, providing a gesture from the main chat icon, preferably removes the keyboard networking system interface from the screen.

In the current embodiment, when a user receives a message, as shown in FIG. 102H, a corresponding chat icon 102041 may be displayed preferably on an edge of the screen. By touching said icon, as shown in FIG. 102I, the corresponding chat field 102051 is displayed on the screen. The user may respond to the received message by touching the reply button 102052. In the current embodiment, preferably, the main chat button/icon is/becomes also displayed on the screen (e.g. to for example to permit forwarding the received message to another user quickly.).

Note that any or all of the chat icons may be moved/dragged on the screen to a new location.

As shown in the exemplary FIG. 102J, the system may include other functionalities. The corresponding interface 102060 (e.g. herein may be referred to as menu bar) may preferably displayed at a same location as the chat (e.g. text) field by for example, pressing a button 102061. As an example, said interface may include any of the buttons, 102062 corresponding to displaying a small history of the chats (e.g. of a chat room), 102063 corresponding to displaying a large history of the chats, 102064 corresponding to taking a picture and sharing it immediately, 102065 corresponding to selecting a picture from the gallery of the device or from the internet, 102066 corresponding to sharing the location of the device/user, 102067 corresponding to making a phone/video call with the corresponding user, etc. When an image/video/web page is shared with another user, the system may alert the receiving party/device for example by displaying an alerting icon 102068 (see FIG. 102K) on/near the corresponding received chat icon. According to one method, an interaction with said chat and/or alerting icon may display the corresponding image/video/web 102069 on the screen (see FIG. 102L). Said image may partially (e.g. within a pop-up window) or entirely (e.g. within an activity window) cover the content (herein may be referred to as the main content) on the screen. According to a preferred embodiment, as shown in the exemplary FIG. 102M, upon interaction with a/said chat icon 102068 corresponding to a received message content, the received message content may first be shown in a small form factor 102070 (e.g. in a small pop-up window above the main content) on the screen. Upon interacting with said small message content 102070 (e.g. or the small window) said received massage content may be enlarged 102069 on the screen.

Note that a message content may be any type of content such as a photo, an image, a video, an audio, a link, a web page, etc.

According to a preferred method, repeating said interaction with said chat icon and/or alerting icon may remove said corresponding message content (e.g. image/video/web page) from the screen. According to a preferred method, said message content (e.g. image) may be forwarded to a third party by said receiving party using the/a forwarding means. According to one example, said forward means may be long pressing on the corresponding chat icon. In this case, the contact list may be presented on the screen to select a desired third party. Other methods are described in this application.

One, some or all of the features of the picture editing applications described in previous patent applications filed by this inventor may be used with the keyboard networking system of the invention. According to one embodiment, when a user receives a content such as a photo or a web page, he may open it as described, draw on it and share back or with others. This way, users can share a content and chat above it by wiring in the corresponding chat field and/or the content (as described in the previous applications), and/or draw on the content for real time precision. For that, drawing, handwriting means, color selection, etc. may be presented to the user on the screen.

Note that any of the applications of the invention (e.g. such as the keyboard networking system/application) described herein may be activated/get focus (e.g. of the operating system) by providing a gesture from (e.g. a permanent very narrow and/or invisible bar-shape window located on) an edge of the screen towards inside the screen as described herein and in the previous patent applications filed by this inventor. The interface of an application (e.g. of the invention) activated as such may replace or brought over at least a portion of (e.g. the interface/content of) any application that has been/is running on the screen before said gesture was provided. Providing a gesture at any moment from an edge of the screen to activate a function (e.g. such as bringing an interface of another application on the screen) regardless of (e.g. the interface of) an (e.g. any) application which is miming on the screen have been described herein and in the previous patent applications filed by this inventor. (e.g. Note that said window located on an edge of the screen may have any other form factor/shape.). Preferably, when said interface is brought above at least a portion of the interface/content of said any application, both interfaces/contents may be visible and/or interactable (e.g. simultaneously).

According to a preferred embodiment, a method may be used to permit shortcuts in an application (e.g. such as a messaging application of the invention). As an example, a gesture provided from an edge of the screen in a first predefined direction towards inside the screen may correspond to a first predefined procedure such as providing an interface for typing a message in a text field and sharing it as described above, while a gesture provided from an edge of the screen in a second predefined direction towards inside the screen may correspond to a second procedure such as providing an interface for taking (e.g. through a camera interface) or selecting (e.g. through the gallery interface) a photo/picture/video and optionally type a message on it (e.g. as described) and sharing it with others, and so on. The camera interface may be related to any camera such as a camera integrated within the device or it may be (e.g. wirelessly or through wires) connected to an external camera.

As an example, a gesture provided from the right edge of the screen in lower-left direction inside the screen may bring a camera interface on the screen. The user then may take a photo or video, optionally type on it or make another type of editing, and then share said (e.g. edited) photo/video. According to one method, the contact list for selecting one or more users to share said photo/video may be presented to the user upon providing said gesture before the camera interface is displayed, or said contact list may be presented at the stage of sharing said photo/video.

Note that such gestures from an edge in different directions may be used for any other function.

Methods of (e.g. none-aggressive) advertisement have been described in the previous applications by this inventor. Such methods may be used with the keyboard networking system, content control systems, etc., of the invention or in any other social networking application. According to one method, as shown in the exemplary FIG. 102N, a means such as button 102071 may be located in the menu bar 102060 of the system. As shown in FIG. 102O, interacting with said button may display a number of choices (e.g. icons, small images, large images, links to ads, etc.) of advertisement on the screen. Preferably, said choices of advertisement may be in form of small icons displayed on the menu bar 102071 to save space. At least an advertisement (e.g. herein may be referred to as one or a plurality of ads) may be transmitted/delivered, preferably on-line, in real-time or in none real time, from a remote server, to the device of a user who uses a social networking application (e.g. to a sender). Said at least one advertisement may be presented to said user preferably upon his/her request (e.g. by providing a predefined interaction by the user) or automatically upon accomplishment of a condition such as when the user selects a contact (e.g. from a contact list or by interacting with a chat icon) (e.g. Note that the term ‘chat’ used herein may be referred to socializing with others using any kind of messaging means such as through a simple text typed in a text box, (editing and) sharing photos and/or videos, etc.). The user may select one or more of said advertisements and share said advertisement/s with a number of (e.g. selected users from the contact list).

The advertisement/s transmitted from a server to such a user (e.g. sender) may be based on one or more parameters such as for example, the sender's and/or the receiver's habits, taste, location, geolocation, behavior, and/or any other condition. The user may select one (e.g. or more) of said advertisement choices by interacting with the corresponding icon. Upon said interaction according to one method, the user can watch at least a preview of said advertisement. After selecting an advertisement the user may share-with/send it to the corresponding party in the chat room (of the corresponding chat icon 102073) for example by pressing the send button 102074. Note that as described before/herein the shared advertisement may be the advertisement itself and/or information (e.g. reference/link) corresponding to said advertisement.

As shown in the exemplary FIG. 102P, preferably, on the receiving device, the chat interface/icon 102080 corresponding to a received message content may include an alerting means 102081 that alerts the user of receiving a message content preferably other than text (e.g. an advertisement). By providing a predefined interaction such as touching said icon, as shown in FIG. 102Q, the system may display the corresponding received message content (e.g. an advertisement) 102091 on the screen of the received device. An interaction preferably with the same icon may remove said advertisement. Said advertisement) may be (e.g. edited and) forwarded to a third party as described earlier in this application for other contents (e.g. photos), for example, in FIGS. 102K to 102L or in FIGS. 103A to 103H. Note that as described before/herein said received message may be a content (e.g. an advertisement) and/or information (e.g. a link/reference) corresponding to a/said content (e.g. advertisement).

Note that a user may also share a (e.g. an edited) content such as an image with users of any other application such as Facebook, Tweeter, Whatsapp, etc.

Note that according to one embodiment, a number of one or more advertisements (herein maybe referred to as a list of advertisements) may be presented on the screen based on one or more predefined conditions such as when a user selects a contact/user (e.g. to chat with).

As mentioned, advertisements may be (e.g. real time) advertisements provided/transmitted by a remote server to (e.g. a sender in) a/the social networking system/application and/or they may be predefined advertisements integrated within a/said social networking system/application (e.g. the keyboard networking system) (e.g. at a prior time). Said advertisements may be based on one or more conditions such as the/a sender's behavior/habits (e.g. what he/she types or watches), and/or the/a receiver's behavior/habits, geolocation of each of the respective users/devices, etc.

Note that, after the destination/receiving party is defined on a sender device, a number of advertisements corresponding to said destination party may be transmitted to said sending device (e.g. to the sender's application) (e.g. for being selected and/or shared).

According to a preferred method of advertising, a system/method of compensation may be applied for the users sharing a message contents such as advertisements with others. According to one embodiment, a user (e.g. a sender) sharing advertisements with others (e.g. receivers) (e.g. with his/her friends using said application on their devices (i.e. within the network of the corresponding messaging application), or optionally with the users of another application) may get/totalize reward-based compensation (e.g. points (e.g. that can be transformed to discount on when buying related goods), money, etc.) for each predefined number of advertisements that he/she share (e.g.) with others (e.g. with other users of said application or with the users of any other application, etc.). Such compensation may be calculated, for example, based on the number of advertisements shared by a sender, with who being shared, when and/or where being shared, etc. Based on the number of points received, a user may get a compensation such as a gift, a sum of money, etc., preferably by the advertising company, or another entity. Optionally, the user receiving an advertisement and/or the owner/provider of the application may get some compensation/reward (e.g. preferably if he/she (e.g. the/a receiving party) views/opens/activates/interacts-with an (a received) advertisement).

When an advertisement message is received in a receiving device, preferably an alerting information may notify the receiver. As an example, said alert may be a corresponding logo, a sign such as a Dollar sigh ($) displayed on the corresponding chat icon (e.g. 102080 of FIG. 102P), a link corresponding to said advertisement, or the like. Note that, according to one method, said information alert (e.g. the logo) may not be the same as the advertisement content itself but rather representing it. Said information may be supplied/transmitted (e.g. directly or through/a server) by the sender, the corresponding advertiser, or another entity.

According to one method, if a user (e.g. selects an advertisement content and) shares a message such as an/said advertisement content or a (e.g. a link to) said/an advertisement regarding BMW cars, upon sharing said message, a BMW logo or a link to that logo may (also) be transmitted to the receiving device. According to one aspect, said logo may be provided along with the ad or be selected/provided manually by the sender. Alternatively, a system/application or a related entity such as a server used by the application and/or by the advertiser may automatically define/discover information relating to the ad (e.g. find out the selected ad is related to BMW cars) through any means such as image recognition system, analyzing a text within/related to/supplied with the ad, or the like. In any case, said logo then may be displayed on a location on the receiving device screen. As an example, in the keyboard networking system/application of the invention, said logo may be displayed on the corresponding chat icon (e.g. 102080) on the receiving device. According to another example, in the content control (e.g. maskie) system/application of the invention, after selecting an ad from a list, the sending user manually or the system automatically may dispose/locate said ad or the corresponding logo on a desired location on a main content (e.g. a photo) or above a mask on said main content. After sharing said content with friends, on a receiving device said logo may be displayed on the corresponding location on the said main content/mask. Preferably, instead of said advertisement content and/or the logo, a link (e.g. attached/referenced/tagged to said location/mask) corresponding to said advertisement and/or said logo may be sent to the receiving device.

According to one method, (e.g. in the current examples) preferably on a receiving device, upon interacting with said logo, chat icon, location on the main content, mask, or the like, the corresponding advertisement may be activated/shown on the screen of the receiving device.

Optionally, (e.g. in addition) the owner/provider of the (e.g. the messaging) application/system may require monetization such as a fee (e.g. from an advertiser) for providing/making-available an (e.g. his/her/its) advertisement to users (e.g. senders) who share his/her/its advertisements with other users (e.g. within the network) of the corresponding application based on different parameters such as the number of adds being shared by senders, the number of clicks provided by the receivers on the received ads, the number of viewed (said received) ads by the receivers, the amount of related goods purchased by senders and/or receivers of the corresponding/said ads, etc. Note that, the owner of the messaging application may use any other method of monetization.

Note that the source of an advertisement may be from many different sources such as from a server delivering said advertisement in real-time or none-real time to a device (e.g. wherein a corresponding social application is installed), from a user re-sharing a received advertisement, etc.

Note that the term ‘advertisement’ or ‘ad’ used herein may be referred to an advertisement content or a content relating to an advertisement. As an example, such a content may be a logo, a link to an advertisement, a small advertisement that may be enlarged by interacting with it, etc.

The embodiments described in this application may be applied when sharing any content such as images, videos, audio, an advertisement, a link to a content such as an advertisement or a webpage, etc.

Note that the methods of (none-aggressive) advertisement (e.g. an advertisement is most of the time is received from a friend or from a sender which is known to the receiver (e.g. he/she is in the receiver's contact list)) described herein have significant advantage over the traditional methods of advertisement (e.g. an advertisement received from a source stranger to the receiver). While in the latter most of the time the receiving party ignores the received advertisement, in the (non-aggressive) method of advertising of the invention, in most cases a receiving party will open/view a received advertisement, because it is received from a friend of from a known party (and in a discrete manner).

In addition, the methods of none-aggressive advertisements described herein can be significantly low-cost because advertisements are mainly distributed by individuals (e.g. private users) to individuals (e.g. friends to friends). These methods are also much more viral than the traditional methods of advertisement because each individual usually has hundreds or maybe thousands of users/friends/contacts in his/her contact list. The traditional methods of advertisement are usually based on sending advertisement/s to a user (e.g. of an application) by an unrelated third party (e.g. a party which is not in the contact list of the device (e.g. of the sender) or of the application (of the user), etc.). For example, a such unrelated third party is Google which send such ads to (e.g. random) users. Said types of advertisements are generally ignored by the receivers (e.g. average of clicks on such an add is less than 0.1%) and mostly bothers the receivers. The methods of advertisement of the invention are based of sending advertisements by a sender to a related/familiar/known party (e.g. usually a friend, selected from the/a sender's contact list). In addition such an advertisement is usually sent as a message which may be opened/viewed by the receiver if/when he/she desires. Therefore such an advertisement is not aggressive and the chances that such an advertisement be opened/viewed by a receiver is very high (e.g. tens of percent).

Note that the principles of sharing advertisements described herein may be used with/within any (e.g. social networking) application wherein for example, a friend shares one or more advertisements with other friends (e.g. contact/s in a contact list of his/her device), with a group of followers, with a community of users of an (e.g. a social) application, etc.).

Optionally, the principles of sharing advertisements described herein may be used regardless of any other application. As an example, a social messaging application may be created wherein its principal feature/subject is preferably sharing advertisements with others/friends. As an example, an (e.g. a simple) interaction (e.g. a gesture from an edge of the screen (e.g. in a predefined direction towards inside the screen as described herein)) may bring an interface corresponding to a list of advertisements on the screen. The user may select one or more of said advertisements and share them with other party/ies (e.g. using/from a contact list (e.g. presented to the user upon an interaction or automatically)). Optionally, upon said (simple) interaction (e.g. said gesture), the system may first pop-up a contact list so that the user may first select at least one party, then the system may present said list of advertisements to the user to select one or more of said advertisements and share it/them with the selected user/s. Any of the sender and the receiver may be rewarded as described herein.

According to one embodiment, in an application of the invention, a sender may edit a picture/video by for example typing on it and then share said picture/video with, for example, a number of (e.g. one or more selected) users of said application (e.g. or optionally, another application). As an example, after a photo/video is presented on the screen, a user may provide a swiping action on a location and in a desired direction on said photo/video. A keyboard may pop up on the screen. The user then may type a text. The text will preferably be presented on the location and in the direction of said swiping action. This matter has already been described in detail in the previous patent applications filed by this inventor. As an example, in FIG. 103A a photo 103000 is being taken using a camera of a device (e.g. and confirmed) and is presented to a user on the screen of said device (e.g. in a social networking application). The user may share said picture as is or he/she may write on it before sharing. In this example, a user has provided a gesture 103001 on a desired location and in a desired direction to indicate to the system that the text he/she is going to enter should start at the location of the beginning of the gesture and in the (indicated) direction of the gesture 103001. Upon providing said gesture, a keyboard may preferably become available on the screen. Optionally, said photo is being taken through a camera interface brought by a processor on the screen upon providing a gesture from an edge of the screen as described herein. Upon providing said gesture from the edge of the screen, a Contacts button 103002 becomes available on the screen. FIG. 103B shows a text 103101 being entered by said user (e.g. using a keyboard which, as an example, have been popped up upon providing said gesture) wherein said text is displayed and located on said photo as indicated by said gesture. After selecting one 103102 or more users from a list of contacts (e.g. not shown) using the Contacts button 103002, the user then may share said edited picture with said one or more users (e.g. of preferably said application). Note that when a user (e.g. “Tom”) (e.g. from a contact list) is selected, preferably, a send button 103103 becomes available on the screen.

Note that (e.g. after providing a gesture (e.g. 103001) corresponding to entering text) instead of a keyboard to input such a text, any other input system such as a speech-to-text or handwriting systems may be used for the same purpose.

According to one embodiment, upon opening a received message content (e.g. even for the first time) such as an image (e.g. a photo) or a video, the system may be adapted to permit a receiver to edit said received message content immediately. FIG. 103C shows the shared image content of FIG. 103B received on the device of a user (e.g. Tom) to which said image content has been sent by the sender (e.g. Joe). Note that, preferably, upon receiving said image content, a corresponding chat room icon/button 103201 pops up on the screen of the receiving device. According to preferred method, by interacting with said icon/button 103201 the received image content becomes available on the screen. Optionally said image content may automatically be displayed on the screen upon receiving it.

According to one embodiment, an image received as such may be editable immediately. As an example, the receiving user may immediate provide a gesture 103202 in a desired direction on the opened picture and start to type on it. The exemplary FIG. 103D shows a text 103203 being typed as such. The user may also add more edits such as drawing on the picture. In this example, if the user presses the send button 103204, the system may preferably send (e.g. back) the new edited image (e.g. back) to the sender (e.g. Tom) 103201 which had been selected by interacting with the chat button 103204. Alternatively, as shown in FIG. 103E, before sending the edited image, the user may select one or more (e.g. preferably, one) other users (e.g. Ben) 103205 to send (e.g. to forward) said edited image to. Note that a send button 103115 may preferably become available when user opens a received message.

According to one embodiment, a user may chat with a plurality of users simultaneously (e.g. preferably, one at a time). As an example, a plurality of chat icons may become available on the screen by selecting the corresponding users from the/a contact list (e.g. of the application/device) and/or by receiving message/s from other users of the application. Note that a chat icon may correspond to a single user (e.g. herein may be referred as a single chat) or it may be related to a group of users (e.g. herein may be referred to as a group chat). A user may select an icon by interacting with it (e.g. touching it). Preferably, at any instance at least one of the chat icons is selected. If there is only one chat icon available on the screen, said chat icon is selected by default. When a user sends a message content (e.g. by pressing the send button) said message content is preferably sent to the user/s of the selected chat icon/s.

As an example, in FIG. 103F, three chat icons 103301 to 103103 corresponding to chatting with three different contacts are popped-up/displayed on the screen. The user of the application (e.g. the keyboard networking system/application of the invention) on the device 103300 may chat with any of said three users (e.g. one at a time) by selecting (e.g. touching) the corresponding chat icon. As such, the user may switch between contacts by providing an interaction with the corresponding chat icons. In the example of FIG. 103F, chat icon 103303 is selected, so when the user of the application on the device (e.g. the sender) touches the send button 103304, the corresponding content (e.g. an edited image, a text, an audio, etc.) will preferably be send to the contact corresponding to the selected contact. In the example, of FIG. 103G, the user has switched to another chat room by (e.g. simply) touching (e.g. and therefore selecting) the chat icon 103302. At any moment, the sender may open an additional chat room by opening a list of contacts (e.g. by touching the Contacts icon 103305) and selecting an additional user from said list. Preferably, said contacts are users of the corresponding messaging/networking application. FIG. 103H shows a new user/chat icon 103307 selected and added to the chat list through a contact list (e.g. not shown) after interacting with the Contacts button 103305. Note that by selecting a new user the corresponding chat icon (e.g. in this example, 103307) will preferably be selected. In this case, if the user presses the send button, the (e.g. edited) message content (e.g. in this case, the (e.g. edited) received photo) will be sent to said selected user. Note that in the exemplary FIGS. 103F to 103H, the image of FIG. 103E is not shown (e.g. but may be considered as included).

Note that when a message content received from a sender is opened on a receiving device, for example, by interacting with the corresponding chat icon, said chat icon will preferably become selected. As such, if the user receiving said message content (e.g. and editing it) does not select any other user and presses the send button, the system will preferably send the (e.g. edited) message content (e.g. back) to said sender.

According to one embodiment, a predefined interaction such as a long pressing action on a chat icon may remove said chat icon from the screen. If the removed chat icon has had the focus and there are more chat icons on the screen, then preferably, one of the other chat icons may automatically get the focus (e.g. is selected). Optionally, a (e.g. same) predefined interaction with the contacts icon may remove the chat bar (e.g. all of the chat icons and the contacts icon) from the screen. In this case, according to one embodiment, the next time that a user brings up a chat icon on the screen, the corresponding chat bar may include the removed chat icons too. According to another embodiment, said chat bar may not include the removed chat icons.

Not that according to one embodiment, the chat bar may not include the contacts icon/button. In this case, according to one method, the Chat bar may be moved on the screen by a predefined interaction such as by a long press and move/drag action on a chat icon, and a chat icon may be deleted by a predefined interaction such as a (very) long pressing action without moving/dragging action on said chat icon.

Note that the keyboard networking system of the invention may use one or more remote servers e.g. cloud servers) and any messaging system for operations such as storing shared contents, transmitting the shared contents, computing the shared content/information, etc.

Different tools may become available when editing an image. As an example, a text resizing tool, a text moving tool, a font tool, a pencil to draw, a color picker to change the color of the text and/or the drawings, etc., may be available when editing an image. Said tools may be displayed on the screen close to user's fingers of the user's hand holding the device (e.g. at the bottom of the screen) to permit a full one-hand photo taking, editing and sharing procedure. Also, the chat icons and/or Contact icon may preferably be located on the screen based on this principle. Note that preferably substantially all of the tools, icons, buttons, etc. may be moveable (e.g. draggable) on the screen.

Note that the edits may become integrated within the image or they may be separate information that can be sent to another user's device separately from the image. As such according to one aspect, an image already sent to a receiving device or to the cloud server may not be sent again and only the edit information may be sent to it. As such upon receiving said edit portion, the system may combine said already received image and said edit information and show the result as the edited image on the receiving device. Alternatively, the system may send said image from the cloud server to the receiving device and preferably combine it locally with the edit information sent by the sender. Note that, in order

Note that any type of image (e.g. picture, video, etc.) may be edited (e.g. by writing/typing a text over it, by adding a mask over at least a portion of it, etc.). As an example, an image to be shared may be an advertisement image. As such a user sharing an advertisement content/image may add (e.g. by typing in a desired direction as described) a message/text over said advertisement content/image. In addition, any other (e.g. virtual(e.g. a mask/emoji) and/or none virtual (e.g. audio) contents (e.g. add-ons) may be disposed/tagged above at least a portion of an advertisement content/image.
Note that the advertisement list/choices may be presented in any order and/or on any location on the screen, and can be selected by any kind of interaction.

As mentioned before, at any moment, a quick interaction may pop-up/enable an interface corresponding to selecting and sharing an advertisement. As an example, a gesture provided from an invisible bar located on an edge of the screen towards a predefined direction inside the screen may be related by a processor to a process of sharing advertisements. In the exemplary FIG. 104A, providing a gesture 104001 from the/an invisible bar located on an edge (e.g. in this example, on the right edge) of the screen towards upper-left inside the screen may be related by a processor to bringing a choice of advertisements (e.g. icons) 104101 on the screen as shown in FIG. 104B. A user may select an (e.g. at least one) advertisement (e.g. 104102). as shown in FIG. 103C, upon selecting said advertisement (e.g. icon) preferably a larger image 104200 corresponding to the selected advertisement (e.g. icon) may be displayed on the screen. Optionally, the user may edit said advertisement (e.g. type a message in a desired direction over it by providing a gesture 104201 starting from a desired location and in a desired direction and, as shown in FIG. 104D, and typing a text 104202 which preferably starts from said location and in said direction), optionally make a drawing 104203 on said advertisement, and (e.g. optionally after confirming the (e.g. edited) advertisement) send/share said (e.g. edited) advertisement to/with a number of one or more selected user/s (e.g. 104204) of said application (e.g. or another application). Note that, in this example, the send button 104205 is displayed/enabled on the screen after a contact 104204 is being selected for example by opening a list of contacts by interacting with the Contacts button 104200. Optionally, instead of a list of small icons/logos, a scrolling procedure may be used to present one or more large advertisements to the user (e.g. one by one). Any other method may be used for the same purpose.

According to one method, a content such as an (e.g. edited or unedited) (e.g. selected) advertisement may be sent/shared with others in form of a (e.g. URL) link/reference corresponding to said (selected) advertisement. On a receiving device, interacting with a corresponding member of the GUI of the application with which said content is shared, the corresponding content/advertisement) may be (e.g. retrieved and) printed on said receiving device.

Note that in the exemplary FIG. 104B, a choice/list of icons/logos 104101 corresponding to different advertisements is displayed on the screen after a gesture 104001 is provided from (e.g. an/the invisible window in form of a bar located on) the edge of the screen. For that, a thin and/or invisible window 104000 in form of a bar is preferably permanently installed on said/an edge of the screen. Said window is installed to capture said gesture by the/a chatting/social networking application of the invention before the window of any other application available on the screen. This matter has already been described in detail herein and in the previous patent applications filed by this inventor. The user may select an advertisement, select a (e.g. one or more) user/s (e.g. of said application) from a list of contacts/users (e.g. displayed for selection) upon interacting with the Contacts icon 104103, and send said advertisement (e.g. or a corresponding URL link) to said selected user/s. Note that other directions may be considered. As an example, from an/said edge of the screen, providing a gesture upwards or downwards may respectively correspond to executing a first (e.g. recording an audio message and (later/then, to) optionally sharing it with one or more other parties) or a second function (e.g. calling a (e.g. predefined party (e.g. an emergency call), etc.)

According to one embodiment, a user/sender editing an advertisement content (e.g. an image) and sending it to others may get some (e.g. extra) rewards (e.g. from a corresponding (e.g. third party) advertiser).

On the receiving device, if a receiver of an advertisement clicks on the corresponding member of GUI to cause (e.g. retrieving and/or) viewing/displaying said advertisement (e.g. on the screen of his/her device or elsewhere), said receiver may be rewarded (e.g. as an example by the principles of the rewarding procedures explained by this inventor or otherwise). In addition, upon/based-on said viewing/displaying action, the sender (e.g. the sharing party) of the advertisement may also be rewarded.

Note that in the chatting (e.g. keyboard networking) system/application of the invention, any type of message may be shared/sent between parties. For example, upon sharing an audio message/file by a sender, on a receiving device (e.g. the corresponding chat icon may pop up and) an alerting means on the corresponding chat icon may alert the receiving party of an incoming message. Upon interacting with said chat icon, according to a first method, said audio file/message may be played. According to a second method, an audio player interface may first be displayed on the screen and the user may activate said audio player to listen to said audio message. Other methods may be considered.

In the example of FIG. 104A, the gesture 104002 (e.g. provided from (e.g. a narrow/invisible) window (not shown) located on and/or along an edge 104007 of a (e.g. (corresponding) device) may be related to bringing up the contacts list or the contacts icon as describe before, then preferably upon selecting a contact/user, preferably an interface relating to drafting/typing a text message (e.g. in text box) and sending it to others may be presented on the screen, and the gesture 104003 may be related to bringing an interface relating to (e.g. a camera for) taking a photo, eventually editing it, and sharing said (e.g. edited or none edited) photo. Note that according to one method, if a virtual content such as a photo is displayed (e.g. in an interface/view of) the keyboard networking system/application (e.g. for editing and/or sharing), then upon selecting a contact (e.g. from the contact list or upon touching a chat icon) the corresponding chat/text box does not open unless the user (e.g. again) interacts with the corresponding chat icon. As an example, in the example of FIG. 103E, after selecting the chat icon/user 103205, the system does may open the chat box/text corresponding to the selected chat icon. If a user wants to send a text message to the selected user before sharing said image with said selected chat icon/user, then he/she may preferably touch said chat icon/button again to open the corresponding chat box/text. Note that according to one method, such text message may be sent separately from said image, while according to another method, said text message may be combined with the image and be sent along with said image (e.g. by pressing a (any of the) send button. According to one embodiment, at least on the receiving device, said text may be printed on the screen along with (e.g. under) said image as a single view.

According to another method, when a user selects a contact, the system opens the corresponding text box/field regardless of having or not having a selected virtual content on the screen.

According to one embodiment, a gesture provided from an edge of the screen in a predefined direction towards the screen may result in taking a screenshot. Said screenshot may be edited as described above/herein. Alternatively, upon providing such a gesture, the system may bring up/display a (e.g. preferably, the last) screenshot on the screen. As an example, a user may take manually a screenshot. The screenshot may be stored in the memory of the corresponding device as the last screenshot. As shown in FIG. 104A, upon providing a predefined gesture 104004 or alternatively 104004/1 from an edge of the device, the system may display/make available said screenshot on the screen, preferably, such that to be editable immediately as described herein. In this example, upon providing a predefined gesture 104005 or alternatively 104005/1 from an edge of the device, the user may access the gallery of images for example so that to select one or more images/videos from the gallery (e.g. for editing and/or sharing).

Note that the gesture provided from an edge of the screen as described herein may be used to execute any function. As an example, providing a gesture from (e.g. a thin and/or invisible zone in form of a bar located on) an edge of a device towards (e.g. a predefined direction) inside the screen ay correspond to providing an emergency call, bringing up an audio interface to input (e.g. and record) audio and preferably sharing it with others, etc.

Note that any of the functions accessed through a gesture provided from an edge of the screen, may be activated through another means such as by interacting with a corresponding button available within the corresponding (e.g. messaging) application (e.g. see the exemplary buttons 102060 of FIG. 102N corresponding to the keyboard networking/messaging application/system of the invention.

Note that after providing a gesture as such, in addition to activating the corresponding function/s (e.g. bringing a corresponding content such as a photo on the screen), the system may display/make available a contact list icon/button or alternatively a contact list as described herein. For example, when a user provides a gesture to access the gallery and selects a photo, the system may also display the contact icon/button. By interacting with said icon a (e.g. an scrollable) contact list may preferably be displayed on the screen so that the user can select one or more users to share said photo with said one or more users.

As mentioned before, providing a gesture from a thin and/or invisible window towards (e.g. any direction, a predefined point, in a predefined direction, etc.) inside the screen of a device (e.g. smartphone) may correspond to displaying a camera interface (e.g. for taking a picture and/or a video, confirming it, zooming, etc. as known by people skilled in the art) the screen of said device. The corresponding camera may be a camera of the device and/or an external camera preferably wirelessly (e.g. using Bluetooth components and protocols) connected to said device.

Note that the current wearable/external cameras that are connected to the handsets (e.g. smartphones) usually have a physical button to take a picture which makes taking a picture unprecise and/or non-discrete. On the other hand, if such cameras use an interface on the connected device to take a picture, the user is obliged to open a corresponding interface on said device by focusing on the screen and/or looking at the screen to provide a specific interaction with the screen to take a picture, deviating the wearable camera from its target and/or frustrating the user. By providing a gesture from an edge of the device the user may take a picture without deviating the camera from the target (e.g. taking a picture while looking at the target). This action is extremely easy and discrete.

According to one embodiment, such a camera may be combined with (e.g. detachably attached to, integrated within, etc.) (e.g. facing to others) a wearable device such as a (e.g. sun/eye) glasses. As such while a user wears such glasses, he/she may direct the camera to a target (e.g. by moving the head/face towards the target (e.g. a person, place), provide a gesture from an edge of the screen of the/a connected device (e.g. a smartphone) to activate the corresponding camera's interface on the screen of said device, provide an interaction such as a tapping action on said interface/screen to (e.g. activate the camera and) take a picture. After eventually confirming said picture (e.g. not necessarily), said picture may be (e.g. memorized locally on the device or remotely on a server, and) used by any application, procedure, function, etc.

FIG. 105A shows, as an example, a user 105001 wearing (e.g. eye) glasses 105002. A camera (e.g. facing to others) 105003 is integrated within said glasses. Said camera is wirelessly connected to a smartphone 105000. The user may direct the camera towards a target (e.g. in this example, two sitting girls), and provide a gesture 105004 from the edge of the screen towards (e.g. if necessary, in a predefined direction) inside the screen to activate the camera (e.g. bringing the corresponding camera interface on the screen). According to one method, upon said gesture, the camera also takes a picture, while according to another method, after said gesture, a predefined interaction such as a tapping action anywhere on the screen may results in taking a photo. In FIG. 105B, a photo 105006 is taken. Preferably, the user may be required to confirm it. Optionally, no confirmation is required. The user may select one or more parties as described herein and send the photo by providing a predefined interaction such as pressing the send key 105007, providing a gesture from the edge of the screen (e.g. in a predefined direction), etc. Alternatively, as shown in FIG. 105C, the user may edit said photo (e.g. type a text on it) and then send it to others.

Note that more than one camera facing to different directions (e.g. towards user's face, towards back, towards sides, etc.) may be integrated within the glasses.

Note that the examples used herein are used to describe the principles of the inventions. Such inventions are not limited to the examples and they are in broader scale. For example, the methods of activating a glasses camera from a corresponding device (e.g. a smartphone) may be used to take videos and share them as described herein for the photos.

Note that a content such as a photo or video (e.g. taken by a sender or provided by another source) may be stored in a server and the corresponding information (e.g. link) may be used to download/retrieve it within a (e.g. sender's) device. As an example, such a link may be shared with (or sent to) others by a/said sender. (e.g. After bringing up the camera interface) according to one method, after taking a photo, a predefined interaction such as a tapping action anywhere on the photo or a gesture provided from the edge of the device as described herein may be related to by the processor to sending said photo to a predefined receiver/party. By using such method, without looking at his/her device, a sender may take a photo (e.g. confirm it) and send it to a predefined receiver/party.

Note that, a first number of gestures provided from an edge of the screen of a device may be related to activating a first number of procedure and a second number of gestures provided from an/said edge of the screen of said device may be related to activating a second number of procedures.

According to one method, after bringing up the camera interface, a predefine interaction such as a taking a photo

According to preferred embodiment systems for taking photos described herein may be used with the keyboard networking system of the invention. By integrating such a system, a user may take a photo and share it instantly with at least the other users of the application. Before sharing said photo, the user may also edit it as described herein.

The keyboard networking application described herein may be used with only one hand to provide, edit and share any content such as a text, an image, a screenshot, etc. with other users of said application.

Note that the social networking systems/applications and methods of (creating and) sharing contents such as advertisements described herein may preferably use contacts that are known to a sender (e.g. contacts in the contact list of his/her device/smartphone, a group of his/her followers, a community of users of a social) application that he/she uses, etc.). Additionally or alternatively, said contents may be shared with the users of any other application.

According to a preferred method of compensation, a person re-sharing a shared/received an advertisement may also be rewarded as described herein, and so on.

According to one embodiment, an advertising entity/company may be authorized to upload an ad (e.g. advertisement) to a server used by an application (e.g. of the invention) upon accomplishment of a condition such as paying a fee that may vary based on some parameters such as the duration of the ad, duration of availability, geographic zone target, type of good being advertised, etc. Note that a content (e.g. image) may be an image sourced from a gallery of images (e.g. on a device), from a camera (e.g. immediately after taking a photo) (e.g. automatically and/or directly), or other communication or storage device/system.

As an example, if a user takes a photo using a camera (e.g. a camera of the corresponding device) said photo may be directly (e.g. without user's intervention) displayed within a window of the chat application/system of the invention. Said photo may be shared immediately/directly from the chat application.

According to one method, the chat interface, partially or all, may be brought up on the screen upon providing an interaction such as providing a gesture from an edge of the screen towards inside the screen, from a menu such as the notification bar of the device, etc. The chat interface may be removed by providing a predefined interaction such as providing a gesture in the opposite direction on the screen, from a menu of the device, etc.

According to one method, a (e.g. incoming) message may be presented in an (e.g. automatically, linear) scrolling manner

Systems and methods of controlling a content by hiding and/or unhiding at least a portion of the content preferably after being shared, on the devices receiving said shared content (herein may be referred to as Maskie application) are described in this and the previous patent applications by this inventor. According to one embodiment, the keyboard networking of the invention may use/be combined with such a systems and methods. Said patent applications are being incorporated entirely by reference in the current patent application.

As a reminder, the content control system (e.g. Maskie) is described herein briefly through exemplary FIGS. 106A to 106K.

In FIG. 106A, an image (e.g. a selected photo locally from the device in use or from an out source (e.g. web), a photo just being taken, a video) (e.g. herein may be referred to as “main (virtual) content”) is brought in a window of Maskie application and a menu bar is displayed above it. Touching the menu removes the menu, as shown in FIG. 106B. Re-touching brings it back. In FIG. 106C, a number of masking contents (e.g. masks) are displayed on the screen by touching the menu icon 106102. In FIG. 106D, a user has selected one of said masks, resized it and located (e.g. by dragging or the like) on a desired portion to hide said portion of the image. In FIG. 106E, a contact list is presented to the user to select one or more contacts and share said masked image with others. Before sharing said image with others, the user has the option to define who user among the selected contacts who will receive said masked image can remove the mask from the image and who can not. The user may also be given the option to choose when and under what condition a mask cab ne removed. The user has also the choice to block or unblock a mask after sharing the masked content on the receiving device on the picture at any moment.

The history of chats between users may be memorized and displayed on a user's device upon request as shown in FIG. 106F.

The Maskie application may have a security means to protect the shares content by not permitting to take a screenshot from a protected content by for example by an authorized user to move the mask. In this case, a user may cover at least two desired locations of a content/image to be shred and an authorized party receiving the content can move only one mask at a time or he/she cannot move all the masks at the same time. If a receiving user takes a screenshot or a photo from the screen, all masks get blocked an cannot be moved anymore. This matter has been described in a previous patent application filed by this inventor. Exemplary FIGS. 106G to 106J, describe such security system. FIG. 106G shows a received image on the device a receiving party. Said image is a secured image having three masks and said receiving party is authorized to move said masks. As an example, in order to read the message under said masks, the receiving party can move one mask at a time only (e.g. see FIGS. 106H, 106I, 106J). After moving a mask and releasing it, said mask will go back to its original location on the image and the user will be able to move another mask and so on.

According to one embodiment, when a user selects a user as an authorized user for moving the masks as such on a received content, a means such as button may appear on the interface and the user can use said means (e.g. button) to protect the content as described. In FIG. 106K, a security means 106301 is presented to the user after a user has put two masks on a photo and authorized a contact to move said masks. By pressing said security button, the selected content will not be able to move/relocate said masks at a same time (e.g. he can move one mask at a time). In this example, another means 106302 is presented to the user sharing said photo. Said means is a time and date means defining when and for how long a blocked mask may be removed and/or an unblocked mask may become blocked.

As mentioned, the keyboard networking system and the Maskie application can be combined. Preferably, the main interface of the combined applications may be the keyboard networking system interface, and when a user desired to edit a content, interacting with a means such as a button in said main interface may switch the system to the Maskie application (and vice versa).

Note that in some paragraphs/embodiments, for simplifying the description, principles, features, methods, etc. (e.g. providing a gesture from an edge of the screen for quickly sharing contents such as text, images, videos, etc.) are being described without referring to the corresponding application. It is understood that such principles, features, methods, etc. may be used with any of the (e.g. social messaging) applications described herein or with any (e.g. social messaging) application in general.

Note that, the term “mask” may be referred to any type or means of hiding (e.g. blurring, erasing, disappearing, removing, deleting, covering by another virtual content, etc.) of at least a portion of a virtual content manually and/or automatically. Said at least a portion may be a portion of the main content, hidden or defined to be hidden, manually by the sender or automatically by the system (e.g. arbitrarily or according to some (e.g. one or more) criteria/conditions.)

Note that, a sender may select a masking means/content (e.g. a mask), may resize the masking means/content, may move/position the masking means/content (e.g. by dragging) on a desired location on (e.g. at least) a portion at least the main content,

Note that any of the main contents and the masks may be stored, in a (e.g. one or more) server/s or locally in the user's device, or elsewhere. A main content and/or a mask me be accessed/retrieved/downloaded on a receiving device through means such as a link, reference, ID, etc.

Note that the main virtual content and the masking content are preferably separate layers and are preferably not integrated together to form a single edited content. (e.g. After positioning a mask above a main content) Sharing/transmitting such contents to the device of another user of the application can be based on different methods. As an example, the main content or alternatively the information corresponding to the main content (e.g. nature, ID, reference to the mask stored in a corresponding storage in the receiving device, in the remote server (e.g. cloud) or anywhere else, a link to the main content (in the internet), etc.), and the corresponding mask or alternatively the information corresponding to said mask (e.g. nature, ID, reference to the mask in a corresponding storage in the receiving device, in the remote server (e.g. cloud) or anywhere else, link to mask (in the internet), (e.g. x,y) position (e.g. of the mask on the main content) and preferably other information such as appearing/disappearing, moving/blocking authorizations (conditions/status), time-related information, etc.) are sent to a receiving device and the corresponding application (e.g. Maskie) is adapted to retrieve the main content and position the mask content preferably in the defined position/manner (e.g. as on the sender's device) above the main content (e.g. on the screen of the receiving device.)

A user sharing a (e.g. a selected) content (e.g. an advertisement, a video file, etc.) with others may (e.g. download and) send a link, a reference or the like (e.g. herein may be referred to as a link) to the device of one or more other users (e.g. friends). Said link preferably may be attached/tagged to an element such as a covering content (e.g. a mask), to a portion of said (selected) content, etc. Additionally or alternatively, said link (e.g. alone) may be sent by a sender to another party's device and on the device of the/said another (i.e. receiving) party becomes/gets attached/tagged to a (predefined) element of an (e.g. the corresponding) application. As an example, in the keyboard networking system of the invention, said link may be tagged/referenced to an element such as the incoming message alert and/or the corresponding chat icon. According to one aspect, upon accomplishment of a condition such as interacting with said element, a function may become activated. For example, (e.g. on/through a receiving device,) a corresponding image, advertisement, video, etc., may be displayed/accessed.

While typing a word using a keyboard, most keyboards offer a list of suggested words (e.g. herein may be referred to as a word list) in a zone in form of a bar above the keyboard. According to a preferred embodiment, preferably the/a word list may become available/visible on the screen mainly/only based on a predefined condition such as during typing a word, otherwise (e.g. when the keyboard is on the screen but no word is being typed, or pause occurs during the text entry, etc.) the word list preferably is not available and the dedicated zone to the word list may become available to the interface of another application (e.g. a text editor) which is on the screen. As an example, in most devices, when a keyboard is displayed on the screen the content (e.g. a text field) on the screen is moved above the keyboard. By considering the principles described herein, according to one embodiment, during typing a word said content is preferably moved above the keyboard including the word list, and when (e.g. the keyboard is on the screen and) not typing a word, the content is preferably moved above said keyboard excluding the word list.

As an example, FIG. 107A shows a portion 107000 of the screen of a device such a smartphone wherein a word 107002 is being entered using an on-screen keyboard 107001 of the invention. In this example, the word list 107003 is displayed to show alternative word suggestions. Note that the content 107004 is located above the keyboard 107001 including the word list 107003. In the example of FIG. 107B, the word ‘today’ 107012 is entered after typing a key corresponding to its last character and pressing the space key. In this example, the word list 107003 is disappeared and the content 107004 is moved down by using the freed space 107013 by removing the word list.

Note that in this example, the keyboard of the invention has three horizontal rows only making it reduced in height therefore permitting to type on the screen while seeing/interacting-with most of the content (e.g. image, photo, video, web-page, etc.) which is on the screen.

Space character is a used very often when typing text. As such, when a user types fast, like for any other letter key, he/she may often hit the wrong key when intending to hit the space key. According to one embodiment, when a user types a text (e.g. hits on the letter keys (and some punctuation keys such as the apostrophe key. Any of such keys herein may be referred to as a letter key), during a predefined laps of time (e.g. 300 milliseconds) after each such a hit, a larger zone may be assigned to the space key (e.g. space key may dynamically become larger). After said laps of time, the space key may be reduced back to its original size. As an example, FIG. 107C shows the space key 107015 occupying the entire function bar 107014 (of FIG. 107B) during a laps of time (e.g. starting immediately) after hitting a letter key. After said laps of time, the function bar (and the space key) may get back its/their original form factor 107014. This method may be applied to any other key of the keyboard. This method may significantly augment the speed of typing.

Methods of predicting words by a word predicting system have been described in many patents applications filed by this inventor. A user typing a word generally is cautious about typing at least one of the beginning and/or ending characters of said word by touching the keyboard on/near/adjacent-to said character/s. Any of the word predictive systems described by this inventor may use this principles for predicting words. As an example, any of said word predictive systems may consider that (e.g. at least) the first interaction with the keyboard for entering a word is provided near or adjacent to the desired character. This may require slightly more mental effort from a user typing a word but significantly augments the accuracy of the word prediction system by reducing the number corresponding word choices.

As an example, the keyboard 108000 of FIG. 108A has two large zones 108011-108012 each having three (e.g. horizontal) small zones (e.g. respectively 108001, 108003, 108005 and 108002, 108004, 108006) wherein a sequence of interactions IJUS 108007 corresponding to a word desired is provided. The first interaction is provided on the letter I, therefore for this interaction the system may consider only said letter and the adjacent/surrounding letters preferably within the corresponding large zones (e.g. UJKL or optionally UHJKL). The rest of interactions may be related to the letters for example based on their distance from the corresponding interaction impacts within the corresponding large zones on the keyboard by giving priority to the letters of the corresponding small zones. Methods of predicting words based on dividing a keyboard in (e.g. two) large zones and (e.g. six) small zones have already been described in the previous patent applications filed by this inventor which are integrated in this application by reference. Restricting/relating the first interaction on the keyboard to the interacted and adjacent letters/characters only, augments the accuracy of the predictions but requires from the user more precision of interaction with the keyboard for the first letter of the words. Accordingly, in this example, the word Loud, is proposed as the best match/choice. The system has also proposed some alternative letters (e.g. Lots, lois, impact). Note that according to ne method, such restriction may also be applied to the last letter/character of the words.

According to a second method, (e.g. at least) for the first character, the system may consider only the characters that are at or adjacent-to the interaction point/impact in the corresponding small (e.g. horizontal) zone.

According to another method, (e.g. at least) for the first character, the system may consider only the characters that are at or adjacent-to the interaction point/impact in the corresponding horizontal row of letters of the keyboard.

Note that at least a portion of the interface (e.g. the chat icons, contacts icon) may automatically or manually be located on a desired location on the screen for example to permit on-had usage of the application.

Note that any of the contents or a copy of that may be may be stored locally on a user's device or it may be uploaded and stored to a remote server (e.g. cloud). As an example, when a picture/video is taken, the corresponding file may be stored locally and/or on the cloud. In addition or alternatively, upon taking a picture (or a video), a copy of that may be presented/displayed automatically (e.g. for editing and/or sharing).

According to one embodiment, in a group chat (e.g. a group of users selected among a Contacts list), a user may share a message with a number of selected users of said group. As an example, a member of a group may be enabled to select one or more members of said group and share a message with said selected members.

Note that in this application, the word “advertisement” or “ad” (content) is used to explain a content that is at least one of, displaying an advertisement, is-an-advertisement and it is related to an advertisement (e.g. a link to an advertisement, a link to a web page/site related to said content (for purchasing (e.g. related) goods), etc.)

Note that, a content (e.g. mask) shared with another user may include hidden information/function and may have a different appearance on a/the receiving device. Said information/function may be activated upon accomplishment of one or more conditions. As an example, on a receiving device, at first, a shared content/mask may not show/display any information related to an advertisement (e.g. or it may show a different image related an advertisement), but upon accomplishment of a condition such as when the receiving user interacts with said content/mask, a function corresponding information such as displaying/playing an advertisement or displaying a (e.g. corresponding) web page may be activated. Note that said corresponding information (e.g. ad) may be displayed on the content/mask or it may be displayed anywhere else on the screen of the receiving device. As another example, on a sender device, a user may receive/download a list of contents/advertisements (e.g. contents), select one of the contents/advertisements (e.g. a first logo related to a product/entity) and share it with others. On a receiving device, said content/advertisement (content) may have a different appearance (e.g. may be shown in form of a second logo (e.g. related to the same product/entity). Alternatively or in addition, said shared content/advertisement (content) may include a link to a function or to another content (e.g. a video, a web page, etc.). As another example, on a device sharing a mask said mask may have a different appearance than on the device receiving said mask depending on a condition/s on or related to said receiving device. As an example, if a mask is related to a sun on a sending device because said device is in a sunny environment, on the receiving device said mask may be related to rain if said receiving device is located in a rainy environment.

According to one embodiment, in a social networking system/application, a user of a first device may be enabled to get information from a second device and display it on said first device. Preferably, said information may be authorized to be shared with others (e.g. a number of selected users or alternatively any user) by the user of said second device. According to one example, a user of the second device may enable a number of information/contents such as his/her geographical location, a picture, a video, etc.) to be retrieved from his/her device or from a remote server (e.g. where they are stored (e.g. by him/her)) by a number of selected users of the application or alternatively by the public (e.g. all of the users of the application).

According to one embodiment, when a sender selects a content (e.g. ad) among a number of (e.g. downloaded) contents and share it with others, on a receiving device, a different content related to the shared content may be displayed. Said different content may be of any kind such as for example a different logo, a url, etc. Said different content may be a predefined content or a content which is defined/found through an automated system (e.g. in/from a remote server) and transmitted to the receiving party's device. As an example, when a content (e.g. ad) is selected and shared/sent to one or more other users, some information related to the selected content may be transmitted from the sender's device to a server. Said information may be used to find some other/more (related) content/s and to transmit them to said one or more other users' device/s.

Optionally said different content may be from any source such as the storage of the sending or receiving device.

According to a preferred aspect of the invention, after an advertisement is share by a sender, on a receiving device, said shared advertisement may be interactive. As an example, by interacting with said advertisement, a web page/site for getting more information, placing an order, purchasing goods, etc., may be opened on said device.

Note that a device using the systems/applications of the invention may be of any kind such a smartphone, a smartwatch, a tablet, a TV, etc.

A GUI of an application may have one or more windows to display main contents such a photo, a video, a web page, etc. A location on said GUI may be defined by a user of said application to display a secondary content such as receiving advertisements. As an example, a user may draw a window on a location on (e.g. a GUI of the application which is displayed on) the screen. Said window may be related by the application to display (e.g. received) secondary content/s such as received advertisements. By using this method, the advertisements are directed to a location on the screen based on user's convenience and are less disturbing. Said window may be movable and/or resizable at least by a receiving party and/or automatically. The shape and the size of said window may have a predefined threshold preferably defined by the owner of the application.

According to one embodiment, a user may define where a received message (e.g. image, video, ad, text, etc.) should be displayed on the screen. A view-defining means may be available to said user in the chatting application. Said received message (or a portion of it) may first be shown in a small view/window/form factor (e.g. as a thumbnail). Upon providing an interaction such as interacting with said small view/window said message may be presented in a larger view/window. This method may be applied to any application such as a any of the messaging/chatting application of a/the invention. This method is also very useful for a user using an/any application that (receives and) displays advertisements (e.g. for monetization) because traditionally an advertisement is received on a predefined location on the screen wherein said location is defined by the application and not by the user of the application.

According to one embodiment, on a main content to be shared/send, a sender may define a location for displaying secondary contents such as advertisements. As an example, a user may take a photo, draw a window on it and share it with one or more other users. On a receiving device, advertisements send to said application/device may preferably be displayed within said window. Said advertisements may be interactive. By providing a predefined interaction such as interacting with said window/advertisement, a related content (e.g. enlarged advertisement, webpage (e.g. for purchasing corresponding goods), a different (related) ad, etc.) may be displayed in said window or anywhere else on the screen. According to one aspect, said window may be draggable/movable on the sending device and/or a receiving device.

Note that all of the advertisements described herein may be interactive. Also note that the ads described herein may be selected by a sender and shared with other users, or they may be transmitted from a third party (e.g. remote server) based on some parameters such as based on sender's and/or receiver's (on-line) behavior, geolocation, etc. Note that any of the means/principles described throughout this application may be used to display contents (e.g. advertisements) on a receiving device regardless of its source (e.g. received from a user of the application or received from a third party such an advertiser, etc.)

According to one embodiment, different functions may be assigned to gestures provided in different directions from a chat icon. As an example, general functions (e.g. access to (a) camera, access to gallery of pictures/videos) may be assigned to gestures provides from the (thin) window on the edge of the of the screen, and personalized functions (e.g. such as calling the user corresponding to a (e.g. selected or none selected) chat icon, advertisement choices/list (e.g. based on the characteristics of the user corresponding to the chat icon, for selecting an ad and sharing it), opening the corresponding small or large history, etc.) may be assigned to gestures provided in different directions from a chat icon. As an example, a short or long gesture provided downwards from a chat icon may respectively correspond to opening the corresponding small or large chat history. Also as an example, providing a gesture upwards from said chat icon may correspond to calling the user corresponding to said chat icon. Also as an example, providing a gesture leftwards or rightwards from said chat icon may correspond to (e.g. downloading and presenting) a choice of advertisement contents corresponding to the user's characteristics corresponding to said chat icon.

Note that the chat bar and a/any chat icon and the/a corresponding text field for texting may preferably (e.g. always) be prioritized to be above any other content on the screen preferably including a selected content (e.g. a taken photo/video) within the application. As such, as an example, inside or outside a/the chatting application (e.g. the keyboard networking application of the invention), when a user places a call, selects a virtual content (e.g. takes a photo/video or selects an image from a galley, etc.), accesses a web page, etc., he/she may text or speak about any subject including about the (e.g. virtual) content (e.g. said selects a photo/video or the selected image) which is on the screen. Also as an example, a user may be able to chat (by texting) with a first party and speak (by calling) with a second party simultaneously.

According to one aspect, providing such a gesture from any chat icon may select said chat icon and said chat icon (e.g. said chat icon may get the focus of the system) and activate the corresponding function. According to another example, upon said gesture said function is executed but the focus remains AS IS on its corresponding icon (e.g. where it was) regardless of said gesture. The current aspect may permit to chat/share (text/image) with a first party and simultaneously speak with any (the same or another) party. This procedure may be applied to any function in the keyboard networking system/application of the invention.

According to one method, when a receiving party views/activates an ad (e.g. by interacting with a corresponding mask, chat icon, etc.), the receiving party and/or the sending party may get some amount of reward. Optionally or additionally, the application owner/entity may also be rewarded/compensated.

According to one method, upon demand or automatically, a user sharing advertisements may get information regarding the rewarding campaigns for a product, his/her reward status (e.g. how many points gained, how many more points needed), etc.

Note that any type of message may be sent/shared in the keyboard networking system. As an example, an audio file may be recorded and shared with another user. Upon receiving said file, on the receiving device, (e.g. the corresponding chat icon may pop up on the screen and) an alerting means may alert the receiving party. Upon providing an interaction (e.g. touching the chat icon) or automatically said audio be played, preferably, on the receiving device.

According to one aspect, an advertisement may be directed to any (e.g. open, selected or none selected) chat icon from a third party (e.g. from an entity that is not a member in the contact list of a device receiving said advertisement. (e.g. Google, Facebook)).

Note that, the term “selected chat icon” may herein be referred to a focused chat icon (e.g. button) and the term “open chat icon” may be referred to any of the chat icons in the chat bar regardless of the focus.

A message of any type of the keyboard networking system of the invention may be shared with/sent to other applications. As an example, a virtual message/content such as an (edited) image selected/created using the keyboard networking system may be shared with other applications. As such, according to one method, a share icon/button may be provided/available so that by interacting with said icon/button, a choice of icons/buttons corresponding to different applications (e.g. email, whatsapp, etc.) may be presented on the screen. The user may select one (or more) of said choices to share said (e.g. edited) virtual message/content with one or more users of said selected choice (e.g. in the selected application).

Note that, the term “Chat bar” may herein be referred to a (row of a) number (e.g. one or more) of chat icons and preferably also includes a/the Contacts icon as described herein.

Note that, the term “sender” may herein be referred to a user of an application that sends/shares a message/content of any type to/with one or more other users/parties (e.g. within the network) of said application or with the users (e.g. within the network) of another application.

Note that, the term a virtual content may be an advertisement or it may be related to an advertisement. For example, a virtual content may be a regular photo being linked or referenced to an advertisement but itself does not display/include an advertisement. Alternatively, the window (within a GUI) on which a virtual content is displayed may be related to an advertisement. Preferably based on an interaction such as a touching, tapping, gliding, etc. action with said photo or said window, an advertisement is displayed/activated. The advertisement may be an image, photo, video, a website (e.g. for purchasing goods), etc.

A received message may be replied or forwarded. Any means may be used for such functions. As an example, a forward and reply buttons may be used in the GUI of the keyboard networking system. As another example, a leftward gesture (e.g. on the text box) may be used for reply function and a rightwards gesture (on the text box) may be used for forward function. After providing a forwarding interaction (e.g. rightward gesture or touching the button), a user may select a (e.g. one or more) user/s (e.g. from a contact list (which preferably may be opened upon said forwarding interaction) or from the chat icon bar) to forward the message to a selected user.

Note that in the contact list, preferably, the parties with whom a user has had messaging interaction may be shown on the top of the list.

Note that any content (e.g. an (e.g. a to-be-shared/received) advertisement) or a link to said content, may be attached/related/tagged to any portion of a chat application/interface (e.g. such as to a mask, to a corresponding chat icon on the receiving device) on the sending and/or receiving device/s.

A content may have related contents. As an example, an emoticon may have one or more related emoticons. According to one method, when a receiving party receives an emoticon from a sender, upon providing a predefined interaction such as selecting/touching said received emoticon, or automatically, a number of other emoticons preferably related to said received emoticon may be displayed/presented on the screen of the receiving party's device. As such said receiving party may select one or more of said related emoticons and send them as a reply to said sender. As an example, a “question” emoticon may have a number of (e.g. related) “answer” emoticons. A sender may ask a question by sending a question emoticon to a receiving party. The receiving party may answer to said question by selecting/touching said question emoticon, selecting one or more of the related answer emoticons and send it/them as reply to said sender. Note that this method may be applied to any type of emoticons such as emoticons used in a text (as a character in a text) or none-text (e.g. mask/image) emoticons. Also, note that the method described herein may be applied to any type of (e.g. virtual) content regardless of the appearance/type of said content (e.g. emoticon and/or none emoticon virtual contents) and its related content/s.

As mentioned, a (e.g. virtual) content may have one or more related contents. Upon accomplishment of a condition (e.g. such as touching said content or automatically) one or more related virtual content may be presented to user. As an example, a sender may select/take a first (e.g. virtual or none-virtual) content and relate a (e.g. one or more) second (e.g. virtual or none virtual) content/s to said first virtual content and share said first virtual with one or more other parties. On a receiving device, based on accomplishment of a condition (e.g. upon an interaction or automatically (e.g. based on time)), said second/related content/s may be presented to a receiving party. Note that, said second/related contents may be created and or/related to said first virtual content on the fly (e.g. by said sender or by another entity) or said second/related content/s may be selected among number of (e.g. predefined) choices related to said first content. As an example, a user may select a mask (e.g. the first content), record a message (e.g. the second content) and relate it to said mask, and share said mask (alone or above an image) with one or more other parties. On a receiving device, upon an interaction such as by touching said mask, the recorded message may be played.

Many methods may be used for relating a second content to a first content. As an example, after selecting/creating a first virtual content (e.g. an image) by a user/sender and providing a predefined interacting (e.g. with a location on) said content, an audio and/or video recording interface/means may become available to said user/sender. After recording an audio and/or a video message, said recorded message may be related to said first content. After sharing/sending said first virtual content to others, on a receiving device, upon accomplishment of a (e.g. manual or automatic) condition, said related/recorded audio/video message may be played. As an example, if the receiving user provided a predefined interaction such as interacting with said location on the received image, said related/recorded audio/video message may be played.

It is understood that said first content may have any number of related contents. Also note that said first content and/or said related second content/s may be of any type such as audio, video, image, text, a reference, a link, etc. Note that any of said first and second contents may be invisible and become visible based on accomplishment of a condition.

A user using the keyboard networking system/application of the invention, may select another party (e.g. from the content list) that does not have the application and send him/her a message. In this case, according to one embodiment, said message may be sent to said another party through an external network such as MMS or SMS. On the other hand, a message received through an external network (e.g. MMS or SMS) in a device having the keyboard networking system of the invention, may be redirected to the keyboard networking system of the invention and be displayed/presented using the keyboard networking system user interface/GUI (e.g. as if said message have been received from the network of the keyboard networking system of the invention). As an example, if an SMS is sent to a receiving device having the keyboard networking system of the invention, a corresponding chat bubble/icon may pop up on the screen of said receiving device and an alerting means may alert the receiving party. Upon interacting with said chat icon, the SMS massage may be displayed (e.g. in the corresponding window/view/text-box of the keyboard networking application of the invention) on the screen.

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto. It is to be understood that the drawings are not necessarily drawn to scale, but that they are merely conceptual in nature. It must be noted, that any of the systems, features, means, methods, etc., described in this patent application may be used separately or being combined with systems, features, means, methods, etc., of other different embodiments of the invention.

Note that although in some embodiments the terms ‘a screen’ or ‘a display’ have been used, such terms may be referred to or a touch-sensitive surface.

In different paragraphs of this application, providing a gesture from an edge of the screen towards inside the screen to activate a function or to display an interface is described. It must be noted that such gesture is preferably provided from a window, preferably in form of a thin and/or invisible line which is located (e.g. permanently) on an edge of the screen of the corresponding device, Said window is preferably located on the screen regardless of (e.g. the interface) of any application which is running on the screen. This matter has already been described in detail in different patent applications that have been filed previously by this inventor and that are incorporated herein entirely by reference. Note that such a window may have any other shape.

It must be noted that at least one/some of principle, features, aspects, concepts, etc., described throughout this application may be combined together and used in any portion of the description of the invention herein to enhance the invention. Note that at least one or more of the inventions, concepts, aspects, principles etc. described within this patent application can be used separately or in combination within this patent application or with any other application and/or product.

According to one embodiment, a user sending a text may hide/mask at least a portion of a text by swiping on said portion. The user then may authorize if a receiving party can unhide (e.g. remove the mask) preferably by providing a gesture on the hidden potion (or vice versa) or by moving the mask (see FIGS. 107A and 107B). This matter has been described in the previous patent applications filed by this inventor. Such system of hiding/unhiding at least a portion of text may be applied to any text such as a text message created/typed by a user of the keyboard networking system.

Note that any electronic device such as a mobile phone, tablet, smartwatch, etc. may be used by any of the inventions, concepts, aspects, principles etc. described within this patent application or with any other application and/or product.

Note that all principles, methods, systems, embodiments, features, functions, etc. described in this application are not limited to the examples described herein. They may be used for a broader purpose.

Note that the history window, at any moment, may present a portion of any (e.g. main) text field that preferably is interactable and/or interacted by a user.

It must be noted that in some portions of this application an invention may be described by referring to a specific content and/or function, it is understood that any other content and/or function may be used with any invention described herein.

Note that in some paragraphs, the term ‘e.g.’ is not used to save time and space when giving an example in parenthesis. It is understood that phrases written in parenthesis are generally mentioned as examples.

1. A system comprising:
A first device having a touch screen;
A messaging application running in the background within said first device; and
A window related to said application, said window, regardless of the window of any other application displayed on the screen, is located on an edge of said touch screen while said messaging application is running;
Wherein upon providing a gesture from said window of said messaging application towards inside of said touch screen, a function related to said messaging application is executed.

2. The system of claim 1, wherein said window is in form of a narrow and/or invisible line.

3. The system of claim 1, wherein said function is displaying a contact list to select a contact from.

4. The system of claim 1, wherein said function is displaying an interface related to a camera.

5. The system of claim 1, wherein said function is taking a picture and/or a video.

6. The system of claim 1, wherein said function is presenting a list of one or more advertisements to select an advertisement and share it with a selected contact.

7. The system of claim 1, wherein said function is displaying an interface of said messaging application above at least a portion of said window of said any other application displayed on said touch screen.

8. The system of claim 1, wherein said function is related to recording an audio.

9. The system of claim 1, wherein upon receiving a message from said first device on a receiving device, a small window related to the first device is displayed on an edge of the screen of said receiving device.

10. A system comprising:
A first device having a touch screen;
A messaging application running within said first device;
A small window related to a contact used by said application, said window located on an edge of said touch screen; and
A list of advertisements presented on said touch screen;
Wherein based on selecting an advertisement from said list of advertisements, a message is sent to a second device related to said contact.

11. The system of claim 10, wherein upon receiving said message on said second device, a small window related to said first device is displayed on an edge of the screen of said second device.

12. The system of claim 11, wherein upon interacting with said window said advertisement is displayed on the screen of said second device.

13. A messaging system comprising:
A first device having a touch screen; and
A messaging application running within said first device;
Wherein based on selecting an advertisement from said list of advertisements, a message is sent to a second device related to said contact.

14. The system of claim 13, wherein upon receiving said message on said second device, a small window related to said first device is displayed on an edge of the screen of said second device.

15. The system of claim 14, wherein upon interacting with said small window said advertisement is displayed on the screen of said second device.
